(19) United States
(12) Patent Application Publication
(10) Pub. No.: US 2026/0223952 A1
(43) Pub. Date: Aug. 6, 2026

(54) AEROSOL PROVISION DEVICE

(71) Applicant: Nicoventures Trading Limited, London (GB)

(72) Inventors: Benjamin ZAINUDDIN, London (GB); Lois MOLLISION-BALL, London (GB); Zara VALBUENA-LOPEZ, London (GB)

(21) Appl. No.: 19/141,972

(22) PCT Filed: Dec. 21, 2023
(86) PCT No.: PCT/EP2023/087497

§ 371 Date: Jun. 20, 2025

(30) Foreign Application Priority Data
Dec. 23, 2022 (GB) 2219648.9
Dec. 23, 2022 (GB) 2219650.5

(51) Int. Cl. A24F 40/57; H05B 1/02

(52) U.S. Cl. CPC A24F 40/57; H05B 1/0252

(57) ABSTRACT

An aerosol provision device configured to receive at least a portion of an article comprising aerosol generating material, the aerosol provision device comprising: one or more aerosol generators arranged to cause aerosol to be generated from the aerosol generating material; and a controller configured to control the one or more aerosol generators during a session of use. During the session or use the controller is configured to control the one or more aerosol generators: (i) to heat to a first target operating temperature T1 during a first time period t0-t1; (ii) to heat to a second target operating temperature T2 during a second time period t1-t2; (iii) to heat to a third target operating temperature T3 during a third time period t2-t3; and (iv) to heat to a fourth target operating temperature T4 during a fourth time period t3-t4.

### CROSS-REFERENCE TO RELATED APPLICATIONS

This present application is a National Phase entry of PCT Application No. PCT/EP2023/087497, filed Dec. 21, 2023, which claims priority from Great Britain Application No. 2219648.9, filed Dec. 23, 2022, and claims priority from Great Britain Application No. 2219650.5, filed Dec. 23, 2022, each of which are fully incorporated herein by reference in their entireties.

### TECHNICAL FIELD

The present invention relates an aerosol provision device, an aerosol provision system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium. Separately induction heating systems are known to be used as heaters.

### SUMMARY

According to an aspect there is provided an aerosol provision device configured to receive at least a portion of an article comprising aerosol generating material, the aerosol provision device comprising:
one or more aerosol generators arranged to cause aerosol to be generated from the aerosol generating material; and
a controller configured to control the one or more aerosol generators during a session of use, wherein during the session or use the controller is configured to control the one or more aerosol generators:
(i) to heat to a first target operating temperature T1 during a first time period t0-t1;
(ii) to heat to a second target operating temperature T2 during a second time period t1-t2;
(iii) to heat to a third target operating temperature T3 during a third time period t2-t3; and
(iv) to heat to a fourth target operating temperature T4 during a fourth time period t3-t4;
wherein temperature T1<T2<T3<T4 and time to <t1<12<t3<t4; and
wherein T1>300° C.

According to another aspect there is provided an aerosol provision device configured to receive at least a portion of an article comprising aerosol generating material, the aerosol provision device comprising:
one or more aerosol generators arranged to cause aerosol to be generated from the aerosol generating material; and
a controller configured to control the one or more aerosol generators during a session of use, wherein during the session or use the controller is configured to control the one or more aerosol generators to a series of temperatures T1, T2, T3 to Tn at time periods t1, t2, t3 to tn, wherein T1<T2<T3<Tn and time to <t1<12<t3<tn.

According to another aspect there is provided an aerosol provision device configured to receive at least a portion of an article comprising aerosol generating material, the aerosol provision device comprising:
one or more aerosol generators arranged to cause aerosol to be generated from the aerosol generating material; and
a controller configured to control the one or more aerosol generators during a session of use, wherein during the session or use the controller is configured to control the one or more aerosol generators to a series of target operating temperatures T1, T2, T3 to Tn at time periods t1, t2, t3 to tn, wherein the series of target operating temperatures are progressive steps up.

According to various embodiments an aerosol provision device is provided comprising a controller which is arranged to set target operating temperatures for one or more aerosol generators according to a heating profile. The heating profile comprises an initial first target operating temperature after which the heating profile progressively steps up during the course of an aerosol generation session. In particular, the heating profile may have a profile wherein the desired operating temperature of an aerosol generator may be arranged to step up in a series of steps, e.g. four or more steps, during an aerosol generation session. The heating profile having a series of steps up (e.g. four or more steps up) as a progression of time may correspond with a first, standard or regular mode of operation known as a “base” mode of operation. When the aerosol provision device is operating in a first or base mode of operation, an aerosol generation session may be arranged to last for, for example, 300 s (5 mins).

A session of use should be understood to commence at time to and according to various embodiments end at time (such as t5 or t9) when the controller may switch the one or more aerosol generators OFF. Once a session of use has been commenced at time t0, there is a ramp up time or time to first puff before an aerosol may be generated. The ramp up time or time to first puff may end at a time t_start. An aerosol generation session may be considered as commencing at time t_start and according to various embodiments may be considered as ending at time (such as t5 or t9) when the one or more aerosol generators may be switched OFF.

According to other embodiments a heating profile having a series of steps (e.g. four or more steps) up as a function of time may correspond with a second mode of operation known as a “boost” mode of operation. When the aerosol provision device is operating in a second or boost mode of operation, the session of use and the aerosol generation session may be shorter. For example, the length of the aerosol generation session may be shortened to, for example, 180 s (3 mins). A common feature of both the first and second operating modes is that the temperature set for the aerosol generator may be >300° C. throughout the entirety of the session of use (and hence also of the aerosol generation session). Furthermore, the minimum target operating temperature of the aerosol generator during the session of use (and hence the aerosol generation session) may be higher when the aerosol provision device is operated in a second or boost mode of operation compared with the minimum target operating temperature of the aerosol generator when operating in a first or base mode of operation. According to various embodiments, the minimum target operating temperature in the second or boost mode of operation may be, for example, 360° C. By contrast, the minimum target operating temperature in the first or base mode of operation may be lower, for example, 320° C. In other embodiments, the minimum target operating temperature in the second or boost mode of operation may be, for example, 410° C. and the minimum target operating temperature in the first or base mode of operation may be lower, for example, 370° C.

According to various embodiments when the aerosol provision device is operating in a first or base mode of operation the controller may be configured so that the first target operating temperature T1>305° C., T1>310° C. or T1>315° C. during the first time period t0-t1.

In other embodiments, when the aerosol provision device is operating in a first or base mode of operation the controller may be configured so that the first target operating temperature T1>360° C., T1>370° C., or T1>380° C. during the first time period t1.

In other embodiments, when the aerosol provision device is operating in a first or base mode of operation the controller may be configured so that a fourth target operating temperature T4>420° C., T4>425° C. T4>430° C., or T4>435° C. during the fourth time period.

In other embodiments, when the aerosol provision device is operating in a first or base mode of operation the controller may be configured so that a final target operating temperature Tn>420° C., Tn>425° C. Tn>430° C., or Tn>435° C. during a final time period tn.

According to various embodiments when the aerosol provision device is operating in a second or boost mode of operation the controller may be configured so that the first target operating temperature T1>305° C., T1>310° C., T1>315° C., T1>320° C., T1>325° C., T1>330° C., T1>335° C., T1>340° C., T1>345° C., T1>350° C. or T1>355° C. during the first time period t0-t1.

In other embodiments when the aerosol provision device is operating in a second or boost mode of operation the controller may be configured so that the first target operating temperature T1>395° C., T1>400° C., T1>405° C., T1>410° C., T1>415° C., T1>420° C., or T1>425° C. during the first time period.

In other embodiments, when the aerosol provision device is operating in a second or boost mode of operation the controller may be configured so that a fifth target operating temperature T5>420° C., T5>425° C. T5>430° C., or T5>435° C. during the fifth time period

In other embodiments, when the aerosol provision device is operating in a second or boost mode of operation the controller may be configured so that a final target operating temperature temperature Tn>420° C., Tn>425° C. Tn>430° C., or Tn>435° C. during a final time period tn−1-tn.

More generally, embodiments are contemplated wherein the controller may be configured to control the one or more aerosol generators so that during a session of use T1>305° C., T1>310° C., T1>315° C., T1>320° C., T1>325° C., T1>330° C., T1>335° C., T1>340° C., T1>345° C., T1>350° C. or T1>355° C. during the first time period t0-t1.

The one or more aerosol generators may be arranged to internally heat an aerosol generating article. According to other embodiments the one or more aerosol generators may be arranged to externally heat an aerosol generating article.

In some embodiments, (i) T1=360±10° C.; (ii) T2=365±10° C.; (iii) T3=370±10° C.; and (iv) T4=375±10° C.

In some embodiments, (i) T1=410±10° C.; (ii) T2=415±10° C.; (iii) T3=420±10° C.; and (iv) T4=425±10° C.

Optionally, (i) t0-t1=80±10 s; (ii) t1-t2=30±10 s; (iii) t2-t3=30±10 s; and (iv) t3-t4=30±10 s.

The controller may be further configured to control the one or more aerosol generators: (v) to heat to a fifth target operating temperature T5 during a fifth time period t4-t5; wherein T4<T5 and time t4<t5.

In some embodiments, T5 may be 380±10° C. In some embodiments, T5 may be 430±10° C.

Optionally, (i) t4-t5=20±10 s.

The controller may be further configured to control the one or more aerosol generators: (v) to heat to a fifth target operating temperature T5 during a fifth time period t4-t5; wherein T4<T5 and time t4<t5.

The controller may be further configured to control the one or more aerosol generators: (vi) to heat to a sixth target operating temperature T6 during a sixth time period t5-t6; wherein T5<T6 and time t5<t6.

The controller may be further configured to control the one or more aerosol generators: (vii) to heat to a seventh target operating temperature T7 during a seventh time period t6-t7; wherein T6<T7 and time t6<t7.

The controller may be further configured to control the one or more aerosol generators: (viii) to heat to an eighth target operating temperature T8 during an eighth time period t7-t8; wherein T7<T8 and time t7<t8.

The controller may be further configured to control the one or more aerosol generators: (ix) to heat to a ninth target operating temperature T9 during a ninth time period t8-t9; wherein T4<T5<T6<T7<T8<T9 and time t4<15<t6<17<18<t9.

In some embodiments, (i) T1=320±10° C.; (ii) T2=325±10° C.; (iii) T3=330±10° C.; and (iv) T4=335±10° C.

In some embodiments, (i) T5=340±10° C.; (ii) T6=350±10° C.; (iii) T7=360±10° C.; (iv) T8=370±10° C.; and (v) T9=380±10° C.;

In some embodiments, (i) T1=370±10° C.; (ii) T2=375±10° C.; (iii) T3=380±10° C.; and (iv) T4=385±10° C.

In some embodiments, (i) T5=390±10° C.; (ii) T6=340±10° C.; (iii) T7=410±10° C.; (iv) T8=420±10° C.; and (v) T9=430±10° C.

Optionally, (i) t0-t1=70±10 s; (ii) t1-t2=55±10 s; (iii) t2-t3=55±10 s; and (iv) t3-t4=55±10 s.

Optionally, (i) t4-t5=55±10 s; (ii) t5-t6=10±5 s; (iii) t6-t7=10±5 s; (iv) t7-t8=5±2 s; and (v) t8-t9=5±2 s.

According to a further aspect, there is provided an aerosol provision device configured to receive at least a portion of an article comprising aerosol generating material, the aerosol provision device comprising:
one or more aerosol generators arranged to cause aerosol to be generated from the aerosol generating material; and
a controller configured to control the one or more aerosol generators during a session of use, wherein during the session of use the controller is configured to control the one or more aerosol generators,
(i) to heat to a first target operating temperature T1 during a first time period t0-t1;
(ii) to heat to a second target operating temperature T2 during a second time period t1-t2;
(iii) to heat to a third target operating temperature T3 during a third time period t2-t3; and
(iv) to heat to a fourth target operating temperature T4 during a fourth time period t3-t4;
wherein temperature T1>T2>T3>T4 and time to <t1<12<3<t4;
wherein the one or more aerosol generators are operable in at least a first mode and a second mode;
wherein in the first mode the controller is configured to control the one or more aerosol generators, T1>320° C. and T4>380,
wherein in the second mode the controller is configured to control the one or more aerosol generators, T1>350° C. and T4>430.

The first mode may be a base mode. The second mode may be a boost mode.

In the first mode the controller may be configured to control the one or more aerosol generators, T1>320° C. and T4>380.

In the second mode the controller may configured to control the one or more aerosol generators, T1>360° C. and T4>380.

In the second mode, the controller may be further configured to control the one or more aerosol generators: (v) to heat to a fifth target operating temperature T5 during a fifth time period t4-t5; wherein temperature T4<T5 and time t4<t5.

In the second mode, the controller may be further configured to control the one or more aerosol generators: (vi) to heat to a sixth target operating temperature T6 during a sixth time period t5-t6; wherein temperature T6<T5 and time t5<t6.

In the second mode, the controller may be further configured to control the one or more aerosol generators: (vii) to heat to a seventh target operating temperature T7 during a seventh time period t6-t7; wherein temperature T7<T6 and time t6<t7.

In the second mode, the controller may be further configured to control the one or more aerosol generators: (viii) to heat to an eighth target operating temperature T8 during an eighth time period t7-t8; wherein temperature T8<T7 and time t7<t8.

In the second mode, the controller may be further configured to control the one or more aerosol generators: (ix) to heat to a ninth target operating temperature T9 during a ninth time period t8-t9; wherein temperature T9<T8 and time t8<t9.

According to a further aspect, there is provided an aerosol provision device configured to receive at least a portion of an article comprising aerosol generating material, the aerosol provision device comprising:
one or more aerosol generators arranged to cause aerosol to be generated from the aerosol generating material; and
a controller configured to control the one or more aerosol generators during a session of use, wherein during the session of use the controller is configured to control the one or more aerosol generators,
(i) to heat to a first target operating temperature T1 during a first time period t0-t1;
(ii) to heat to a second target operating temperature T2 during a second time period t1-t2;
(iii) to heat to a third target operating temperature T3 during a third time period t2-t3; and
(iv) to heat to a fourth target operating temperature T4 during a fourth time period t3-t4;
   wherein the one or more aerosol generators are operable in at least a first mode and a second mode;
wherein in the first mode the controller is configured to control the one or more aerosol generators to a series of target operating temperatures T1, T2, T3 to Tn at time periods t1, t2, t3 to tn, wherein the series of target operating temperatures are progressive steps up.
wherein in the second mode the controller is configured to control the one or more aerosol generators to a series of target operating temperatures T1, T2, T3 to Tn at time periods t1, t2, t3 to tn, wherein the series of target operating temperatures are progressive steps down.

The first mode may be a base mode. The second mode may be a boost mode.

According to a further aspect, there is provided an aerosol provision device configured to receive at least a portion of an article comprising aerosol generating material, the aerosol provision device comprising:
one or more aerosol generators arranged to cause aerosol to be generated from the aerosol generating material; and
a controller configured to control the one or more aerosol generators during a session of use, wherein during the session of use the controller is configured to control the one or more aerosol generators,
(i) to heat to a first target operating temperature T1 during a first time period t0-t1;
(ii) to heat to a second target operating temperature T2 during a second time period t1-t2;
(iii) to heat to a third target operating temperature T3 during a third time period t2-t3; and
(iv) to heat to a fourth target operating temperature T4 during a fourth time period t3-t4;
   wherein the one or more aerosol generators are operable in at least a first mode and a second mode;
wherein in the first mode the controller is configured to control the one or more aerosol generators to a series of target operating temperatures T1, T2, T3 to Tn at time periods t1, t2, t3 to tn, wherein the series of target operating temperatures are progressive steps down,
wherein in the second mode the controller is configured to control the one or more aerosol generators to a series of target operating temperatures T1, T2, T3 to Tn at time periods t1, t2, t3 to tn, wherein the series of target operating temperatures are progressive steps up.

The first mode may be a base mode. The second mode may be a boost mode.

According to a further aspect, there is provided an aerosol provision device configured to receive at least a portion of an article comprising aerosol generating material, the aerosol provision device comprising:
one or more aerosol generators arranged to cause aerosol to be generated from the aerosol generating material; and
a controller configured to control the one or more aerosol generators during a session of use, wherein during the session or use the controller is configured to control the one or more aerosol generators:
(i) to heat to a first target operating temperature T1 during a first time period t0-t1;
(ii) to heat to a second target operating temperature T2 during a second time period t1-t2;
(iii) to heat to a third target operating temperature T3 during a third time period t2-t3; and
(iv) to heat to a fourth target operating temperature T4 during a fourth time period t3-t4;
wherein temperature T1>T2, temperature T2<T3<T4 and time to <t1<12<t3<t4; and
wherein T1>300° C.

In some embodiments, T1>T3. In some embodiments, T1>T4 In some embodiments, (i) T1=400±10° C.; (ii) T2=350±10° C.; (iii) T3=355±10° C.; and (iv) T4=360±10° C.

In some embodiments, (i) t0-t1=40±10 s; (ii) t1-t2=30±10 s; (iii) t2-t3=30±10 s; and (iv) t3-t4=60±10 s.

In some embodiments, the controller is further configured to control the one or more aerosol generators: (v) to heat to a fifth target operating temperature T5 during a fifth time period t4-t5; wherein T5<T6 and time t5<t6.

In some embodiments, the controller is further configured to control the one or more aerosol generators: (vi) to heat to a sixth target operating temperature T6 during a sixth time period t5-t6; wherein T4<T5<T6 and time t4<15<t6.

In some embodiments, the controller is further configured to control the one or more aerosol generators: (vii) to heat to a seventh target operating temperature T7 during a seventh time period t6-t7; wherein T4<T5<T6<T7 and time t4<15<16<t7.

In some embodiments, the controller is further configured to control the one or more aerosol generators: (viii) to heat to an eighth target operating temperature T8 during an eighth time period t7-t8; wherein T4<T5<T6<T7<T8 and time t4<15<t6<t7<t8.

In some embodiments, the controller is further configured to control the one or more aerosol generators: (ix) to heat to a ninth target operating temperature T9 during a ninth time period t8-t9; wherein T4<T5<T6<T7<T8<T9 and time t4<15<t6<t7<18<t9.

In some embodiments, T1>T4. In some embodiments, T1>T5. In some embodiments, T1>T6. In some embodiment, T1>T7. In some embodiments, T1>T8. In some embodiments T1>T9. In some embodiments, T1=T9.

In some embodiments, (i) T5=370±10° C.; (ii) T6=375±10° C.; (iii) T7=380±10° C.; and (iv) T8=390±10° C.; and (v) T9=400±10° C.

In some embodiments, (i) t4-t5=40±10 s; (ii) t5-t6=20±5 s; (iii) t6-t7=30±5 s; (iv) t7-t8=30±10 s; and (v) t8-t9=20±10 s.

The controller may be further configured to control the one or more aerosol generators to a series of target operating temperatures in another (second) mode of operation, wherein in the second mode the controller is configured to control the one or more aerosol generators to a series of target operating temperatures T1, T2, T3 to Tn at time periods t1, t2, t3 to tn, wherein the series of target operating temperatures are progressive steps up.

The controller may be further configured to control the one or more aerosol generators to a series of target operating temperatures in another (second) mode of operation, wherein in the second mode the controller is configured to control the one or more aerosol generators to a series of target operating temperatures T1, T2, T3 to Tn at time periods t1, t2, t3 to tn, wherein the series of target operating temperatures are progressive steps down.

The maximum operating temperature in the second or boost mode of operation may be, for example, 380° C. or 390° C. The maximum operating temperature in the second or boost mode of operation may be 430° C.

In some embodiments, when the aerosol provision device is operating in a first or base mode of operation the controller may be configured so that the fourth target operating temperature T4>360° C., T4>370° C., or T4>380° C. during the fourth time period t3-t4.

In some embodiments, when the aerosol provision device is operating in a first or base mode of operation the controller may be configured so that a final target operating temperature Tn>360° C., Tn>370° C., or Tn>380° C. during a final time period tn.

In some embodiments when the aerosol provision device is operating in a second or boost mode of operation the controller may be configured so that the fourth target operating temperature T4>395° C., T4>400° C., T4>405° C., T4>410° C., T4>415° C., or T4>420° C., during the fourth time period t3-t4.

In some embodiments, when the aerosol provision device is operating in a first or base mode of operation the controller may be configured so that a final target operating temperature Tn>360° C., Tn>370° C., or Tn>380° C. during a final time period tn.

In another (second mode) of operation, an aerosol provision device may be configured to receive at least a portion of an article comprising aerosol generating material, the aerosol provision device comprising:
one or more aerosol generators arranged to cause aerosol to be generated from the aerosol generating material; and
a controller configured to control the one or more aerosol generators during a session of use, wherein during the session of use the controller is configured to control the one or more aerosol generators:
(i) to heat to a first target operating temperature T1 during a first time period t0-t1;
(ii) to heat to a second target operating temperature T2 during a second time period t1-t2;
(iii) to heat to a third target operating temperature T3 during a third time period t2-t3; and
(iv) to heat to a fourth target operating temperature T4 during a fourth time period t3-t4;
wherein temperature T1>T2>T3>T4 and time to <t1<t2<3<t4; and
wherein T4>300° C.

In an embodiment, during the session of use the controller is further configured to control the one or more aerosol generators:
(v) to heat to a fifth target operating temperature T5 during a fifth time period t4-t5; wherein temperature T4>T5 and time t4<15; and optionally:
(vi) to heat to a sixth target operating temperature T6 during a sixth time period t5-t6; wherein temperature T6>T5 and time t5<t6; and optionally:
(vii) to heat to a seventh target operating temperature T7 during a seventh time period t6-t7;
wherein temperature T7>T6 and time t6<t7; and optionally:
(viii) to heat to an eighth target operating temperature T8 during an eighth time period t7-t8;
wherein temperature T8>T7 and time t7<t8; and optionally:
(ix) to heat to a ninth target operating temperature T9 during a ninth time period t8-t9; wherein temperature T9>T8 and time t8<19.

In an embodiment, (i) T1=400±10° C.; (ii) T2=396±10° C.; (iii) T3=394±10° C.; (iv) T4=392±10° C.

In an embodiment, (v) T5=390±10° C.; (vi) T6=386±10° C.; (vii) T7=384±10° C.; (viii) T8=382±10° C.; and (ix) T9=380±10° C.

The one or more aerosol generators may comprise a pin-shaped heater element.

The pin-shaped heater element may comprise a cylindrical body and a conical tip.

The pin-shaped heater element may comprise an elongate body having a cavity and one or more heater coils arranged within the cavity.

The one or more aerosol generators may comprise a blade-shaped heater element.

The blade-shaped heater element may comprise one or more conductive or resistive tracks. The conductive or resistive tracks may comprise NiChrome (Ni20Cr80).

The one or more aerosol generators may comprise a resistive heater element.

The one or more aerosol generators may comprise an inductive heater element.

The aerosol provision device may comprise a power source, a controller and a heating chamber in which an aerosol generating article is removeable received. The aerosol provision device may be configured for wireless charging.

The aerosol provision device may comprise one or more indicator devices or signalling devices for indicating to a user when the aerosol generator has reached a desired operating temperature and/or when the aerosol provision device is ready to use e.g. after an initial ramp up time. For example, the one or more indicator devices or signalling devices may be arranged to be activated or change state at time t_start i.e. after an initial ramp up time or time to first puff.

According to another aspect there is provided an aerosol provision system comprising:
an aerosol provision device as described above; and
an article comprising aerosol generating material.

The article comprising aerosol generating material may comprise bandcast reconstituted tobacco.

The aerosol provision system may comprise a charging unit having a cavity for removably receiving the aerosol provision device. The charging unit may comprise a moveable cover which is configured to cover the aerosol provision device in a closed configuration. The charging unit may comprise a user display. The user display may be visible to a user when the moveable cover is in a closed position and may be partially or fully concealed or obscured from sight by the cover when the cover is an open position.

The aerosol provision device may comprise a controller and a user interface. The user interface may be activated by a user to cause the aerosol provision device to operate in a first (e.g. base) mode of operation wherein the controller is configured to control the one or more aerosol generators so that the one or more aerosol generators heat to a series of target operating temperatures according to a first heating profile as a function of time. The user interface may also be activated by a user to cause the aerosol provision device to operate in a second (e.g. boost) mode of operation wherein the controller is configured to control the one or more aerosol generators so that the one or more aerosol generators heat to a series of target operating temperatures according to a second different heating profile as a function of time. The first heating profile may relate to a session of use having a total duration t₁ₜₒₜₐₗ and wherein the aerosol generator may be set target operating temperatures between a minimum target operating temperature T₁ₘᵢₙ and a maximum target operating temperature T₁ₘₐₓ. The second heating profile may relate to a session of use having a total duration t₂ₜₒₜₐₗ and wherein the aerosol generator may be set target operating temperatures between a minimum target operating temperature T₂ₘᵢₙ and a maximum target operating temperature T₂ₘₐₓ. The duration of an aerosol generation session may correspond with the period of time subsequent to an initial time to first puff (or ramp up time) i.e. from time t_start onwards through to a time corresponding to the end of an aerosol generation session when no aerosol is intended to be generated. At the end of an aerosol generation session the controller may set a target operating temperature for the aerosol generator which is too low to cause an aerosol to be generated e.g. 20° C. At the end of an aerosol generation session the aerosol generator may be switched OFF i.e. zero current may be supplied to the aerosol generator. According to various embodiments t₁ₜₒₜₐₗ>t₂ₜₒₜₐₗ and/or T₂ₘₐₓ=T₁ₘₐₓ and/or T₂ₘᵢₙ>T₁ₘᵢₙ. According to various embodiments T₁ₘᵢₙ≥320° C. and/or T₂ₘᵢₙ≥360° C.

The aerosol provision device may further comprise a temperature sensor for monitoring or sensing the temperature of the aerosol generator (or heater element) during the course of a session of use or an aerosol generation session. The temperature sensor may comprise a thermocouple, a thermopile or a resistance temperature detector (“RTD”) which may also be referred to as a resistance thermometer. Temperature data measured by the temperature sensor may be communicated to the controller. In particular, when the temperature sensor determines that the aerosol generator or heater element has reached a target operating temperature (e.g. T1, T2, T3, T4 etc.) the controller may be arranged to change the supply of power to the aerosol generator or heater element. The controller may comprise a proportional integral derivative (“PID”) controller which uses a control feedback loop mechanism to control the temperature of the aerosol generator or heater element based on data, information or signal(s) supplied from the one or more temperature sensors.

The article comprising aerosol generating material may comprise a capsule which may be fragmented in order to introduce an additional flavourant or other agent into an aerosol generated in an aerosol generating portion of the article. The article may comprise one or more filters which may comprise e.g. cellulose acetate. The article may comprise one or more ventilation holes formed through an outer layer of the article to aid with cooling of the article. The one or more ventilation holes may be provided >5 mm from the proximal (mouth) end of the article.

According to another aspect there is provided a method of generating an aerosol comprising:
providing an aerosol provision device as described above;
at least partially inserting an article comprising aerosol generating material into a receiving portion of a heating chamber of the aerosol provision device; and
activating the aerosol provision device in order to generate aerosol from the article.

According to another aspect there is provided an aerosol provision system comprising:
an aerosol provision device configured to receive at least a portion of an article comprising aerosol generating material, the aerosol provision device comprising one or more RF generators (resonant frequency generators) arranged to generate a varying magnetic field and a controller configured to control the one or more RF generators during a session of use;
an article comprising heating material which is inductively heated by the one or more RF generators;
wherein during the session of use the controller is configured to control the one or more RF generators: (i) to heat the heating material to a first target operating temperature T1 during a first time period t0-t1; (ii) to heat the heating material to a second target operating temperature T2 during a second time period t1-t2; (iii) to heat the heating material to a third target operating temperature T3 during a third time period t2-t3; and (iv) to heat the heating material to a fourth target operating temperature T4 during a fourth time period t3-t4; wherein temperature T1<T2<T3<T4 and time to <t1<12<t3<t4; and wherein T1>300° C.

### BRIEF DESCRIPTION OF THE DRAWINGS

Various embodiments will now be described, by way of example only, and with reference to the accompanying drawings, in which:

FIG. 1 shows a perspective view of an aerosol provision system comprising an aerosol provision device located within a charging unit, wherein the aerosol provision device may comprise a controller which is configured to cause one or more aerosol generators to heat to a series of different target operating temperatures during a session of use;

FIG. 2 shows a schematic cross-sectional view of part of the aerosol provision device as shown in FIG. 1, wherein the aerosol provision device comprises a pin-shaped heater element;

FIG. 3 shows a schematic cross-sectional view of part of the aerosol provision device as shown in FIG. 1 and an aerosol generating article, wherein a pin-shaped heater element is shown inserted into a distal end of an aerosol generating article;

FIG. 4 shows a perspective view of a standalone aerosol provision device according to another embodiment, wherein the standalone aerosol provision device may be charged directly rather than being charged by a charging unit into which the aerosol provision device is inserted;

FIG. 5 shows a schematic cross-sectional view of the aerosol provision device as shown in FIG. 4 and shows that the aerosol provision device may comprise a pin-shaped heater element which, in use, may be inserted into a distal end of an aerosol generating article;

FIG. 6 shows a schematic cross-sectional view of a pin-shaped heater element which may be used to heat an aerosol generating article according to various embodiments and wherein the heater element may be controlled by a controller so as to heat to a series of target operating temperatures according to a heating profile, wherein the target operating temperatures progressively increase with time during the course of a session of use;

FIG. 7 shows a heating profile according to an embodiment and illustrates a heating profile which may be set by a controller for one or more aerosol generators when the aerosol provision device is operated in a first or base mode of operation having an aerosol generation session time of 300 s, wherein the heating profile has nine progressive steps up in time whilst the target operating temperature of the one or more aerosol generators is maintained ≥320° C. during a session of use;

FIG. 8 shows a heating profile according to an embodiment and illustrates a heating profile which may be set by a controller for one or more aerosol generators when the aerosol provision device is operated in a second or boost mode of operation having a shortened aerosol generation session time of 180 s, wherein the heating profile has five progressive steps up in time whilst the target operating temperature of the one or more aerosol generators is maintained ≥360° C. during a session of use;

FIG. 9 is a side-on cross sectional view of an aerosol generating article partially inserted into a receiving portion or recess of an aerosol provision device according to various embodiments comprising a pin-shaped heater element and wherein the aerosol provision device comprises a controller which is arranged to set the pin-shaped heater element a heating profile as shown in either FIG. 7, 8 or 11; and

FIG. 10 is a cross sectional view of the aerosol generating article shown in FIG. 9 taken along line A-A′ as shown in FIG. 9.

FIG. 11 shows a heating profile according to an embodiment and illustrates a heating profile which may be set by a controller for one or more aerosol generators when the aerosol provision device is operated in a first or base mode of operation having an aerosol generation session time of 300 s.

FIG. 12 shows a heating profile according to an embodiment and illustrates a heating profile which may be set by the controller for one or more aerosol generators when the aerosol provision device is operated in a second or boost mode of operation having an aerosol generating session time of 180 s; and

FIG. 13 shows a heating profile according to an embodiment and illustrates a heating profile which may be set by a controller for one or more aerosol generators when the aerosol provision device is operated in a second or boost mode of operation having a shortened aerosol generation session time of 180 s.

### DETAILED DESCRIPTION

According to the present disclosure, a “non-combustible” aerosol provision system is one where a constituent aerosol generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol generating material is not a requirement.

In some embodiments, the non-combustible aerosol provision system is an aerosol generating material heating system, also known as a heat-not-burn system. An example of such a system is a tobacco heating system.

In some embodiments, the non-combustible aerosol provision system is a hybrid system to generate aerosol using a combination of aerosol generating materials, one or a plurality of which may be heated. Each of the aerosol generating materials may be, for example, in the form of a solid, liquid or gel and may or may not contain nicotine. In some embodiments, the hybrid system comprises a liquid or gel aerosol generating material and a solid aerosol generating material. The solid aerosol generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the non-combustible aerosol provision device may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol generating material, an aerosol generating material storage area, an aerosol generating material transfer component, an aerosol generator, an aerosol generation area, a housing, a wrapper, a filter, a mouthpiece, and/or an aerosol-modifying agent.

As used herein, the term “aerosol generating material” is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

The aerosol generating material may comprise one or more active substances and/or flavours, one or more aerosol-former materials, and optionally one or more other functional material.

The aerosol generating material may comprise a binder, such as a gelling agent, and an aerosol former. Optionally, a substance to be delivered and/or filler may also be present. Optionally, a solvent, such as water, is also present and one or more other components of the aerosol generating material may or may not be soluble in the solvent. In some embodiments, the aerosol generating material is substantially free from botanical material. In particular, in some embodiments, the aerosol generating material is substantially tobacco free.

The aerosol generating material may comprise or be in the form of an aerosol generating film. The aerosol generating film may comprise a binder, such as a gelling agent, and an aerosol former. Optionally, a substance to be delivered and/or filler may also be present. The aerosol generating film may be substantially free from botanical material. In particular, in some embodiments, the aerosol generating material is substantially tobacco free.

The aerosol generating film may have a thickness of about 0.015 mm to about 1 mm. For example, the thickness may be in the range of about 0.05 mm, 0.1 mm or 0.15 mm to about 0.5 mm or 0.3 mm.

The aerosol generating film may be continuous. For example, the film may comprise or be a continuous sheet of material. The sheet may be in the form of a wrapper, it may be gathered to form a gathered sheet or it may be shredded to form a shredded sheet. The shredded sheet may comprise one or more strands or strips of aerosol generating material.

The aerosol generating film may be discontinuous. For example, the aerosol generating film may comprise one or more discrete portions or regions of aerosol generating material, such as dots, stripes or lines, which may be supported on a support. In such embodiments, the support may be planar or non-planar.

The aerosol generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol generating film.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales. The article may be, for example, of a predetermined or specific size that is configured to be placed within or over a heater of the device which is sized to receive the article.

An aerosol generator is an apparatus configured to cause aerosol to be generated from the aerosol generating material. In some embodiments, the aerosol generator is a heater configured to subject the aerosol generating material to heat energy, so as to release one or more volatiles from the aerosol generating material to form an aerosol. In some embodiments, the aerosol generator is configured to cause an aerosol to be generated from the aerosol generating material without heating. For example, the aerosol generator may be configured to subject the aerosol generating material to one or more of vibration, increased pressure, or electrostatic energy.

A consumable is an article comprising or consisting of aerosol generating material, part or all of which is intended to be consumed during use by a user. A consumable may comprise one or more other components, such as an aerosol generating material storage area, an aerosol generating material transfer component, an aerosol generation area, a housing, a wrapper, a mouthpiece, a filter and/or an aerosol-modifying agent. A consumable may also comprise an aerosol generator, such as a heater, that emits heat to cause the aerosol generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The susceptor may be only magnetic, or only electrically-conductive. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

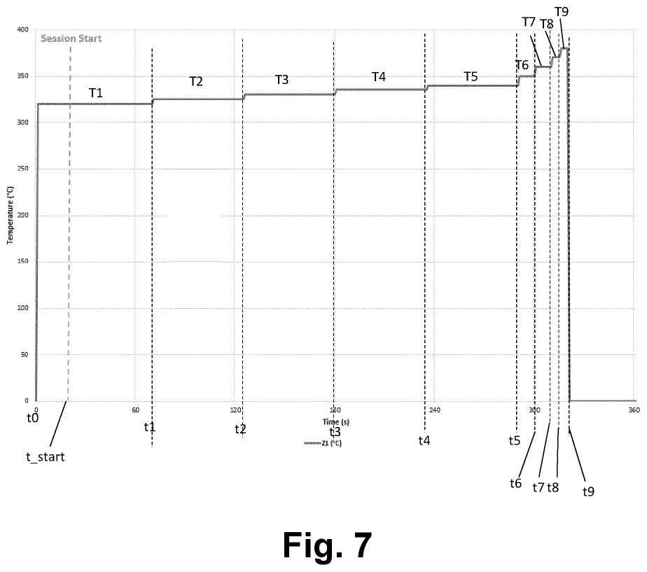

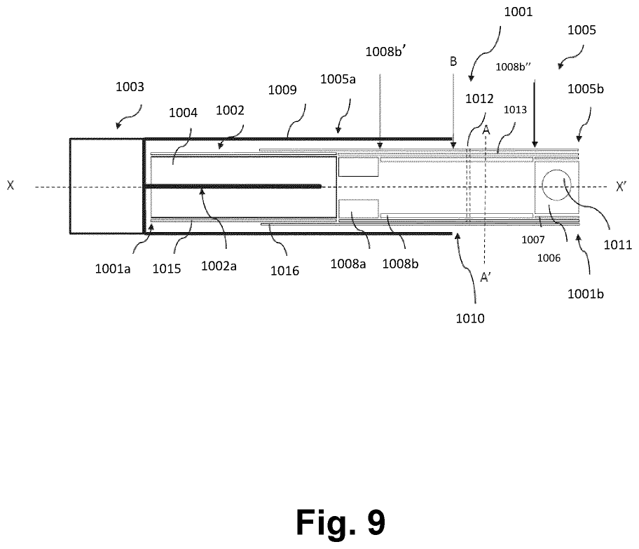

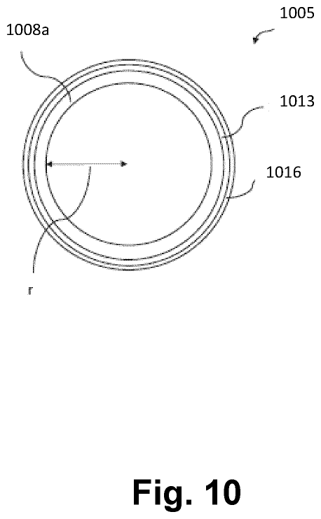

The present disclosure is particularly concerned with various heating profiles as described below with reference to FIG. 7, 8, 11 or 12. An aerosol provision device is described below in particular with reference to FIGS. 1-6. The aerosol provision device may comprise a controller and a heater element, such as a pin-shaped heater element. The controller may be arranged to set the heater element a series of different target operating temperatures according to the heating profiles shown in FIG. 7, 8, 11, or 12. The heating profiles shown and described with reference to FIG. 7, 8, 11, or 12 have been found to result in an excellent sensory experience. The aerosol provision device as disclosed with reference to FIGS. 1-6 and which may be operated according to the heating profiles shown and disclosed with reference to FIG. 7, 8, 11 or 12 has been found to be particularly suitable when used to generate aerosol from an aerosol generating article as disclosed with reference to FIGS. 9-10.

Various different aspects of an aerosol provision device which may be operated according to various heating profiles according to various embodiments will now be described.

FIG. 1 shows an aerosol provision system 10 comprising an aerosol provision device 100 and a charging unit 101. The device is shown located within a cavity of a charging unit 101. The aerosol provision device 100 is arranged to generate aerosol from an aerosol generating article which may be inserted, in use, into the aerosol provision device 100. The aerosol provision device 100 and an article may together form part of an aerosol provision system 10.

As will be discussed in more detail below, the aerosol provision device 100 may comprise one or more aerosol generators. For example, the aerosol provision device 100 may comprise an aerosol generator comprising a pin-shaped heater element as will be described in more detail below. The aerosol provision device may further comprise a controller which may be configured to control the one or more aerosol generators during a session of use. During a session of use the controller may be configured to control the one or more aerosol generators so as to heat to a first target operating temperature T1 during a first time period t0-t1, to heat to a second target operating temperature T2 during a second time period t1-t2, to heat to a third target operating temperature T3 during a third time period t2-t3 and to heat to a fourth target operating temperature T4 during a fourth time period t3-t4. The temperature T1<T2<T3<T4 and T1>300° C. According to embodiments T1≥320° C. Accordingly, the controller may be configured to cause the one or more aerosol generators to heat to a series of target operating temperatures during a session of use wherein the target operating temperatures progressively step up as function of time. For example, the one or more aerosol generators may be controlled by the controller to follow a heating profile wherein the target operating temperature steps up four or more times during the course of a session of use. According to embodiments at all times the target operating temperature of the aerosol generator during a session of use may be ≥320° C.

At an initial time t0, the aerosol provision device 100 and the aerosol generator may be at ambient temperature e.g. 20° C. Other embodiments are contemplated wherein a previous aerosol generation session has been performed and wherein the temperature of the aerosol generator has dropped to a temperature <50° C. Accordingly, at an initial time to the aerosol generator may be at a temperature <50° C.

The aerosol provision device 100 may comprise an elongate structure extending along a longitudinal axis. The aerosol provision device 100 has a proximal end, which is closest to the user (e.g. the user's mouth) when in use by the user to inhale aerosol generated by the aerosol provision device 100. The aerosol provision device 100 also has a distal end which will be furthest from the user when in use. The proximal end may also be referred to as the “mouth end”. The aerosol provision device 100 comprises an opening which leads into a heating chamber.

The aerosol provision device 100 may be removably inserted into the charging unit 101 in order to be charged. However, as discussed in more detail below the aerosol provision device may comprise a standalone aerosol provision device which can be charged directly without requiring a charging unit 101 to recharge the aerosol provision device.

The charging unit 101 comprises a cavity for receiving the aerosol provision device 100. The aerosol provision device 100 may be inserted into the cavity of the charging unit 101 via an opening. The cavity of the charging unit 101 may comprise a longitudinal opening. A portion of the aerosol provision device 100 may comprise a first side. One or more user-operable control elements such as buttons 106 which may be activated in order to operate the aerosol provision device 100 (and in particular to select a desired mode of operation) may be provided on the first side of the aerosol provision device 100. The first side of the aerosol provision device 100 may be received in the longitudinal opening provided in the charging unit 101.

The cavity of the charging unit 101 may have a cross-sectional profile which only permits that the aerosol provision device 100 be inserted into the charging unit 101 in a single orientation. The outer profile of the aerosol provision device 100 may comprise an arcuate portion and a linear portion. The cross-sectional profile of the cavity provided in the charging unit 101 may also comprise a similar arcuate portion and a linear portion. The linear portion of the cross-sectional profile of the cavity may correspond with the longitudinal opening. The charging unit 101 may include a slidable cover 103. When the aerosol provision device 100 is inserted into the charging unit 101 in order to be recharged, the slidable cover 103 may be closed so as to cover the opening into the aerosol provision device 100. In other embodiments, the charging unit 101 may have an alternative cover configuration, such as a hinged or pivoted cover, or no cover may be provided. The charging unit 101 may include a user interface such as display 108, which may be provided at any convenient location, such as in the position shown in FIG. 1.

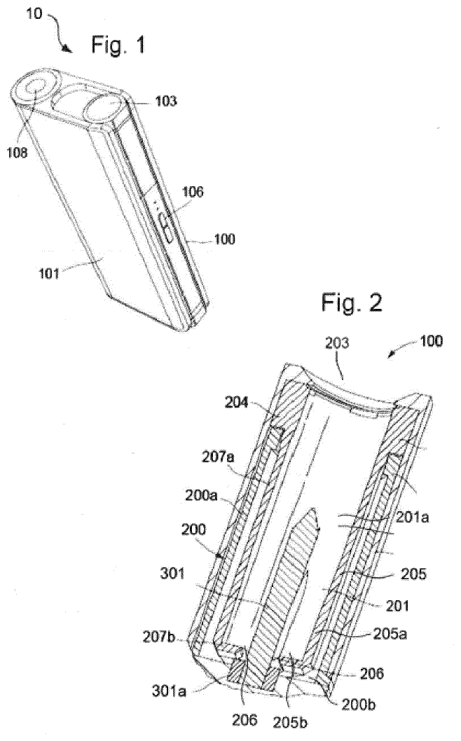

FIG. 2 shows a cross sectional view of a portion of an aerosol provision device 100 according to various embodiments. The aerosol provision device 100 comprises a main housing 200. The main housing 200 defines a device body of the device 100. The aerosol provision device 100 defines a heating chamber 201. A receptacle 205 may be provided which defines a heating chamber 201. An opening 203 may be provided to provide access to the heating chamber 201. The receptacle 205 may comprise a receptacle side wall 205a and a receptacle base 205b. The receptacle base 205b may be provided at the distal end of the receptacle 205. A heating zone 201a may be provided which is configured to receive at least a portion of an aerosol generating article.

A heater element 301 may be provided in a portion of the main housing 200 and the heater element 301 may extend or project into the heating chamber 201. The heater element 301 may comprise a base portion 301a which may be located in a recess provided in a portion of the body of the aerosol provision device 100.

The heater element 301 may comprise an elongate heater element such as a pin-shaped heater element 301. The pin-shaped heater element 301 may comprise a metal such as stainless steel or aluminium. Alternatively, the pin-shaped heater element 301 may comprise a ceramic material. Other embodiments are contemplated wherein the heater element may comprise a blade-shaped heater element (not shown). The heater element 301 may be inserted, in use, into a distal end of an aerosol generating article which is received within the heating chamber 201 in order to internally heat the aerosol generating article.

The housing 200 may comprise a housing wall 200a. The housing wall 200a may extend along the longitudinal axis of the aerosol provision device 100 and may surround the heating chamber 201. The housing wall 200a may, at least in part, define a receiving chamber of the aerosol provision device 100, as the volume which is enclosed within the wall 200a. The housing 200 may comprise a housing base 200b at the distal end of the housing wall 200a. The heater element 301 may be arranged so as upstand from the housing base 200b. The heater element 301 may be arranged so as to protrude through the receptacle base 205b. An aperture 206 may be formed in the receptacle base 205b through which the heater element 301 may protrude. The heater element 301 may be mounted to the receptacle base 205b.

The aerosol provision device 100 may optionally comprise a removal mechanism 204 which may be removably retained to the main housing 200 of the aerosol provision device 100. However, according to other embodiments the removal mechanism 204 may be omitted. The removal mechanism 204 may comprise a tubular wall portion 207a and a base wall portion 207b. After an aerosol generation session has been completed, the removal mechanism 204 may be removed from the main housing 200 of the aerosol provision device 100. As the removal mechanism 204 is removed, the base wall portion 207b of the removal mechanism 204 may be arranged to engage with a distal end of an article which has been located on the pin-shaped heater element 301 so that as the removal mechanism is removed, the base wall portion 207b of the removal mechanism dislodges a spent aerosol generating article from the heater element 301. As a result, the removal mechanism 204 may assist in removing a spent aerosol generating article from a heater element such as a pin-shaped heater element 301.

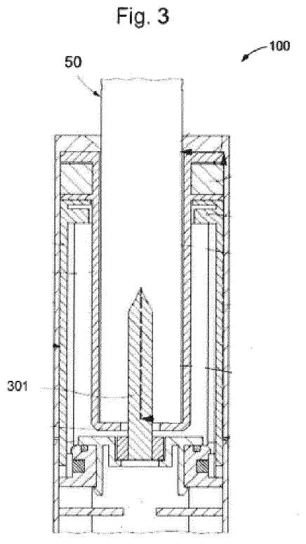

FIG. 3 shows the distal end of an article 50 comprising aerosol generating material located on a pin-shaped heater element 301 of an aerosol provision device 100.

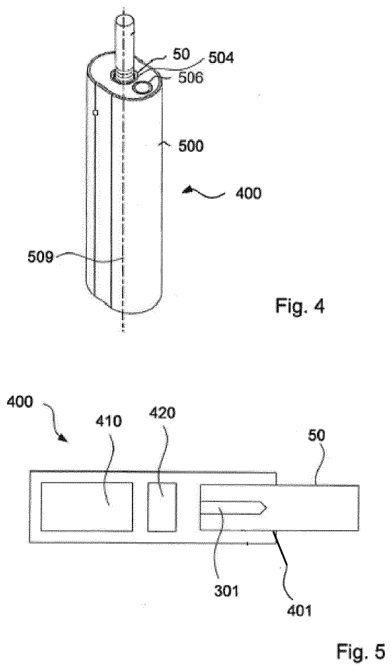

FIG. 4 shows a one-piece aerosol provision device 400 for generating aerosol from an article 50 comprising aerosol generating material. The aerosol provision device 400 comprises an elongate housing 500 which surrounds and houses various components of the aerosol provision device 400. The aerosol provision device 400 has an opening 504 at one end through which the article 50 may be inserted for heating by the aerosol provision device 400. The article 50 may be fully or partially inserted into the aerosol provision device 400 for heating by the aerosol provision device 400. The aerosol provision device 400 may comprise a user-operable control element 506, such as a button or switch, for operating the aerosol provision device 400. For example, the user-operable control element 506 may be pressed in order to cause the aerosol provision device 400 to enter either a first operating mode or a second operating mode. The aerosol provision device 400 defines a longitudinal axis 509 along which an article 50 may extend when inserted into the aerosol provision device 400. The opening 504 is aligned on the longitudinal axis 509.

As will be discussed in more detail below, the aerosol provision device 400 may be operated in a first or base operating mode wherein the desired operating temperature of a heater element may be arranged to step up in a series of e.g. four or more steps during the course of an aerosol generation session which may last, for example, 300 s (5 mins). The aerosol provision device 400 may also be operated in a second or boost operating mode wherein the desired operating temperature of the heater element may also be arranged to step up in a series of e.g. four or more steps over a shorter time period of time. For example, the aerosol generation session may be arranged to last, for example, 180 s (3 mins) in the second or boost operating mode. The minimum target operating temperature of the heater element during an aerosol generation session may be higher when the aerosol provision device is operated in a second or boost mode of operation. According to various embodiments, the minimum target operating temperature in the second or boost mode of operation may be e.g. 360° C. By contrast, the minimum target operating temperature in the first or base mode of operation may be e.g. 320° C.

FIG. 5 shows a cross-sectional schematic view of an aerosol provision device 400 with an aerosol generating article 50 received within a heating chamber of the aerosol provision device 400. The aerosol provision device 400 comprises a power source 410, a controller 420 and a heating chamber 401 in which the aerosol generating article 50 is removeable received. The aerosol provision device 400 further comprises one or more aerosol generators. The one or more aerosol generators may comprise a heater element 301. The controller 420 may be configured so as to control the heater element 301 to heat to a first target operating temperature T1 during a first time period t0-t1, to heat to a second target operating temperature T2 during a second time period t1-t2, to heat to a third target operating temperature T3 during a third time period t2-t3 and to heat to a fourth target operating temperature T4 during a fourth time period t3-t4. The temperature T1<T2<T3<T4 and time to <t1<12<3<t4. The heater element 301 may be inserted, in use, into a distal end of the aerosol generating article 50 which is received within the heating chamber 401 in order to internally heat the aerosol generating article 50.

The aerosol provision device 400 may comprise a resistive heater element such as a resistive heating coil which is arranged to be actuated to heat the heater element 301. An electrical current may be applied directly to the resistive heater element, and the resulting flow of current in the heater element may cause the heater element to be heated by Joule heating. The resistive heater element may comprise resistive material which is configured to generate heat when a suitable electrical current is passed through it. The aerosol provision device 400 may further comprise electrical contacts for supplying electrical current to the resistive material. The resistive heater element may be arranged to transfer thermal energy to the heater element 301 by conduction. Similarly, the heater element 301 may transmit thermal energy to a portion of the aerosol generating article 50 by conduction. The provision of a resistive heating arrangement allows for a compact arrangement to be achieved thereby facilitating device miniaturisation. Furthermore, heating a portion of an aerosol generating article 50 using a resistive heating element such as a pin-shaped heater element 301 wherein the pin-shaped heater element 301 is inserted into a distal end of the aerosol generating article enables a high energy efficiency to be achieved since thermal losses can be minimised.

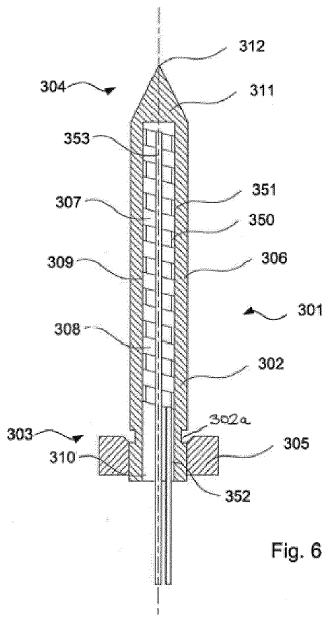

FIG. 6 shows in greater detail a heater element 301 according to various embodiments. The heater element 301 comprises an elongate housing 302 having an inner void 308 or cavity and a resistive heater element 350 located within the inner void 308 or cavity. The elongate housing 302 may be formed from a thermally conductive material such as aluminium or stainless steel. The elongate housing 302 may comprise a coating on its outer surface. The elongate housing 302 is configured to transfer heat from the resistive heater element 350 to an aerosol generating article. The elongate housing 302 has a base end 303 and a free end 304. The base end 303 may be attached to a heating chamber. A mount 305 may be provided at the base end 303 to secure the heater element 301. A groove 302a or region of reduced cross sectional diameter may be provided in the elongate housing 302 towards the base end 303 of the elongate housing 302. The groove 302a or region of reduced cross sectional diameter may act as a thermal break which reduces heat bleed from the heater element 301 into the mount 305 or more generally into a mounting point. The inner void 308 may be at least partially filled, for example, with a filler material.

The filler material may comprise one or more of: (i) a potting compound; (ii) an adhesive; (iii) a thermosetting plastic; or (iv) an epoxy resin. For example, the inner cavity may be at least partially filled with a thermally insulating material. The thermally insulating material may be a potting compound, an adhesive, a thermosetting plastic or an epoxy resin. The potting compound may comprise an epoxy resin. For example, a two-component epoxy may be used consisting of a polymer resin and a hardener which when mixed together causes a chemical reaction which cross-links chemical bonds in the polymer chains to create a tough, rigid and strong compound. The potting compound may alternatively comprise a polyurethane (“PU”) e.g. a thermoset plastic. This may comprise a two-component compound consisting of a base resin with an isocyanate curing agent. Alternatively, the potting compound may comprise a silicone. For example, silicone rubber may be utilised comprising a synthetic polysiloxane polymer that uses an additive catalyser (such as platinum) to transition from a liquid to a solid state.

The heater element 311 has a tip 311 which extends to an apex 312. The resistive heater element 350 may comprise a heating coil 351. The heating coil 351 may comprise an electrically insulative coating, such as a ceramic, to electrically insulate the heating coil 351 from the elongate housing 302. Electrical connection paths may extend from each end of the heater element 350. A base electrical connection path 352 may extend from the distal end of the heater element 350. A return electrical connection path 353 may extend from the proximal end of the heater element 350. The heating coil 351 may be formed from a resistive material, such as a nickel/chrome alloy such as nichrome 80/20 (80% nickel, 20% chromium), an iron/chrome/aluminium alloy or a copper/nickel alloy.

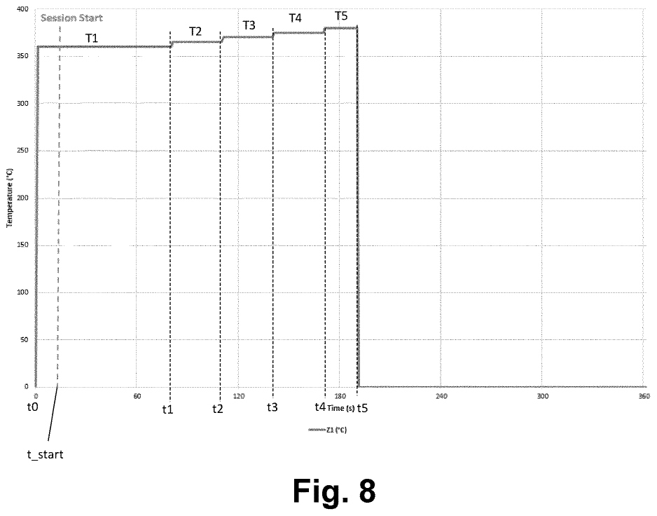

Various heating profiles will now be described with reference to FIGS. 7 and 8. The controller may set a series of target operating temperatures for the one or more aerosol generators (or heating elements) wherein according to an embodiment target operating temperatures T1, T2, T3, T4, T5, T6, T7, T8 and T9 are shown and described below with reference to FIG. 7 and wherein according to another embodiment target operating temperatures T1, T2, T3, T4 and T5 are shown and described below with reference to FIG. 8.

FIG. 7 shows a heating profile according to an embodiment and illustrates a heating profile which may be set by a controller (e.g. controller 420 as shown in FIG. 5) for one or more aerosol generators (or heating element(s)) when an aerosol provision device is operated in a first or base mode of operation. The first or base mode of operation may be arranged to have an aerosol generation session time of 300 s (i.e. 5 mins). The overall session of use may last for 320 s i.e. the overall session of use may comprise a 20 s ramp up time followed by a 300 s aerosol generation session.

As will be discussed in more detail below the heating profile has nine progressive steps up in time during the course of a session of use whilst the temperature is maintained >320° C. during the course of the session of use.

According to various embodiments a controller may be arranged to cause an aerosol generator to assume a first target operating temperature as quickly as possible once a particular operating mode has been selected. There may be a short delay of e.g. 10-20 s during an initial time period wherein the aerosol generator is switched ON but the aerosol generator has not yet reached a desired target operating temperature and hence no aerosol may be generated. This initial time period may be known as the ramp up time of time to first puff. According to embodiments an aerosol generation session may be considered as starting after the end of the ramp up time or time to first puff i.e. at a time t_start. At the end of an aerosol generation session the controller may set a target operating temperature for the aerosol generator which is too low to cause an aerosol to be generated e.g. 20° C. At the end of an aerosol generation session the aerosol generator may be switched OFF i.e. zero current may be supplied to the aerosol generator.

The aerosol provision device may comprise a pin-shaped heater element such as shown and described above with reference to FIGS. 3, 5 and 6 or a blade-shaped heater element. Alternatively, the heater element may comprise an inductive heater element i.e. the heater element may comprise heating material which is inductively heated by an RF generator.

The pin-shaped heater element may comprise a cavity and one or more resistive coils may be located within the cavity. An electrical current may be supplied to the one or more resistive coils under the control of the controller and the resistive coils may become hot due to resistive heating. The pin-shaped heater element may comprise a cylindrical body portion with a conical tip. Other embodiments are contemplated wherein the heater element may comprise a blade-shaped heater. The blade-shaped heater may comprise one or more electrical, conductive or resistive tracks and an electrical current may be supplied to the one or more electrical, conductive or resistive tracks and the electrical, conductive or resistive tracks may become hot due to resistive heating. The conductive or resistive tracks may comprise NiChrome (Ni20Cr80).

Other embodiments are contemplated wherein the heater element may comprise an inductive heater element i.e. the heater element may comprise heating material which is inductively heated by an RF generator. The heater element may therefore form a susceptor comprising heating material that is heatable by penetration with a varying magnetic field, such as an alternating magnetic field. The susceptor may comprise an electrically-conductive material, so that penetration thereof with a varying magnetic field causes induction heating of the heating material. The heating material may be magnetic material, so that penetration thereof with a varying magnetic field causes magnetic hysteresis heating of the heating material. The RF generator may comprise one or more induction coils.

According to various embodiments the controller may be arranged to control the heater element to heat to a first target operating temperature T1 during a first time period t0-t1, to heat to a second target operating temperature T2 during a second time period t1-t2, to heat to a third target operating temperature T3 during a third time period t2-t3, to heat to a fourth target operating temperature T4 during a fourth time period t3-t4, to heat to a fifth target operating temperature T5 during a fifth time period t4-t5, to heat to a sixth target operating temperature T6 during a sixth time period t5-t6, to heat to a seventh target operating temperature T7 during a seventh time period t6-t7, to heat to an eighth target operating temperature T8 during an eighth time period t7-t8 and to heat to a ninth target operating temperature T9 during a ninth time period t8-t9. The temperature of the heater element may be arranged to progressively increase during the progress of a session of use so that temperature T1<T2<T3<T4<T5<T6<T7<T8<T9. It will also be understood that time to <t1<12<3<14<15<t6<t7<t8<t9.

The aerosol provision device may further comprise a temperature sensor for monitoring or sensing the temperature of the aerosol generator during the course of a session of use. The temperature sensor may comprise a thermocouple, a thermopile or a resistance temperature detector (“RTD”) which may also be referred to as a resistance thermometer. Temperature data measured by the temperature sensor may be communicated to the controller. In particular, when the temperature sensor determines that the aerosol generator or heater element has reached a target operating temperature (e.g. T1, T2, T3, T4 etc.) the controller may be arranged to change the supply of power to the aerosol generator or heater element. The controller may comprise a proportional integral derivation (“PID”) controller which uses a control feedback loop mechanism to control the temperature of the aerosol generator or heater element based on data, information or signal(s) supplied from the one or more temperature sensors.

Time t0 may correspond with the time that the controller initially activates or turns ON the aerosol generator or e.g. supplies a current to the heater element. The heater element may be set a first target operating temperature T1 but it may take a few seconds before the heater element either achieves the first target operating temperature T1 or a lower temperature which is sufficient in order to cause aerosol to be generated. This initial time may be referred to as the ramp up time or time to first puff. An aerosol generation session may be considered as commencing after the ramp up time or time to first puff at a time t_start wherein to <t_start<t1. The time to t_start may be e.g. 10-20 s. With regards the heating profile shown in FIG. 7, t_start is 20 s after time t0. According to various embodiments the controller may be configured to control the one or more aerosol generators or heater elements so that the average operating temperature of the aerosol generator(s) or heater element(s) progressively increases after time t_start.

The controller may be configured so that a heating mode is performed wherein as the temperature is progressively stepped up the desired operating temperature which is set for the heater element remains ≥320° C. For example, according to embodiments the lowest target operating temperature T1 which is set for the heater element during an aerosol generation session may be arranged to be ≥320° C.

The specific heating profile shown in FIG. 7 relates to a base or standard mode of operation wherein a user is afforded a total aerosol generation session time of approx. 300 s (i.e. 5 mins). According to this particular embodiment the time from t0 to t_start is 20 s and the time from t_start to t9 (when the aerosol generator or heating element is switched OFF) is 300 s.

| Profile Name | BASE ST7/20/300/GR | | |
|---|---|---|---|
| Time to first puff | 20 s | | |
| (ramp up time) | | | |
| Cumulative Time (s) | Profile Step | Step (s) | Heater temp ° C. |
| 70 | 1 | 70 | 320 |
| 125 | 2 | 55 | 325 |
| 180 | 3 | 55 | 330 |
| 235 | 4 | 55 | 335 |
| 290 | 5 | 55 | 340 |
| 300 | 6 | 10 | 350 |
| 310 | 7 | 10 | 360 |
| 315 | 8 | 5 | 370 |
| 320 | 9 | 5 | 380 |

When the controller sets a heating profile such as the heating profile shown in FIG. 7, the controller may be arranged so that a first target operating temperature T1 is achieved as quickly as possible thereby reducing the time to first puff. For example, with reference to the heating profile shown in FIG. 7 the first target operating temperature T1 set by the controller may be 320° C. Other embodiments are contemplated wherein the first target operating temperature T1 may be 320±10° C. According to various embodiments the first target operating temperature T1 may be 310-315° C., 315-320° C., 320-325° C. or 325-330° C. The controller may be configured to set the heater element a first target operating temperature T1 during a first time period t0-t1. The first time period t0-t1 may be 70 s. Other embodiments are contemplated wherein t0-t1 may be 70±10 s. According to embodiments t0-t1 may be 60-65 s, 65-70 s, 70-75 s or 75-80 s.

A user may activate the aerosol provision device at a time to in order to cause the controller to set the one or more aerosol generators a desired heating profile. For example, a user may activate a user interface (see, for example, user interface 106 as shown in FIG. 1) provided on the aerosol provision device in order cause the one or more aerosol generators to set a desired heating profile for the one or more aerosol generators. Once a user has interacted with the user interface and the controller has set a desired heating profile for the one or more aerosol generators there may be a relatively short time delay (during time t0 to t_start) before the aerosol generator reaches a desired operating temperature and sufficient aerosol can be generated from an aerosol generating article at least partially inserted into the aerosol provision device. The time delay may be referred to as the ramp up time or time to first puff. As shown in FIG. 7, at the end of the ramp up time or once the time to first puff has passed (e.g. at time t_start) then an aerosol generation session may be considered as having commenced. In the case of the example shown in FIG. 7, the ramp up time or time to first puff (i.e. time t0 to t_start) is 20 s. However, according to other embodiments the ramp up time or time to first puff may be shorter or longer than 20 s e.g. 10-15 s, 15-20 s, 20-25 s or 25-30 s.

With regards the heating profile shown in FIG. 7, the controller may set the one or more aerosol generators a first target temperature T1 for e.g. a 70 s period of time immediately upon a user activating the aerosol provision device. If the time to first puff or the ramp up time is 20 s, then it will be understood that the controller may be configured to maintain the desired first target operating temperature T1 of e.g. 320° C. for a further 50 s after the ramp up time or time to first puff has occurred. At the end of the first time period t0-t1 the controller may be configured to set progressively higher target operating temperatures. For example, after the end of the first time period t0-t1 the controller may be arranged to set a second target operating temperature T2 for the one or more aerosol generators. The second target operating temperature T2 may be 325° C. It will be understood that the second target operating temperature T2 is higher than the first target operating temperature T1. Other embodiments are contemplated wherein T2 may be 325±10° C. According to embodiments T2 may be 315-320° C., 320-325° C., 325-330° C. or 330-335° C. The controller may be configured to set the one or more aerosol generators the second target operating temperature T2 during a second time period t1-t2. The second time period t1-t2 may be 55 s. Other embodiments are contemplated wherein t1-t2 may be 55±10 s. According to embodiments t1-t2 may be 45-50 s, 50-55 s, 55-60 s or 60-65 s.

After the end of the second time period t1-t2 the controller may be arranged to set a progressively higher target operating temperature. For example, after the end of the second time period t1-t2 the controller may be arranged to set a third target operating temperature T3 for the one or more aerosol generators. The third target operating temperature T3 may be 330° C. It will be understood that the third target operating temperature T3 is higher than the second target operating temperature T2. Other embodiments are contemplated wherein T3 may be 330±10° C. According to embodiments T3 may be 320-325° C., 325-330° C., 330-335° C. or 335-340° C. The controller may be configured to set the one or more aerosol generators the third target operating temperature T3 during a third time period t2-t3. The third time period t2-t3 may be 55 s. Other embodiments are contemplated wherein t2-t3 may be 55±10 s. According to embodiments t2-t3 may be 45-50 s, 50-55 s, 55-60 s or 60-65 s.

At the end of the third time period t2-t3 the controller may be configured to set a progressively higher target operating temperature. For example, after the end of the third time period t2-t3 the controller may be arranged to set a fourth target operating temperature T4 for the one or more aerosol generators. The fourth target operating temperature T4 may be 335° C. It will be understood that the fourth target operating temperature T4 is higher than the third target operating temperature T3. Other embodiments are contemplated wherein T4 may be 335±10° C. According to embodiments T4 may be 325-330° C., 330-335° C., 335-340° C. or 340-345° C. The controller may be configured to set the one or more aerosol generators a fourth target operating temperature T4 during a fourth time period t3-t4. The fourth time period t3-t4 may be 55 s. Other embodiments are contemplated wherein t3-t4 may be 55±10 s. According to embodiments t3-t4 may be 45-50 s, 50-55 s, 55-60 s or 60-65 s.

At the end of the fourth time period t3-t4 the controller may be configured to set a progressively higher target operating temperature. For example, after the end of the fourth time period t3-t4 the controller may be arranged to set a fifth target operating temperature T5 for the one or more aerosol generators. The fifth target operating temperature T5 may be 340° C. It will be understood that the fifth target operating temperature T5 is higher than the fourth target operating temperature T4. Other embodiments are contemplated wherein T5 may be 340±10° C. According to embodiments T5 may be 330-335° C., 335-340° C., 340-345° C. or 345-350° C. The controller may be configured to set the one or more aerosol generators a fifth target operating temperature T5 during a fifth time period t4-t5. The fifth time period t4-t5 may be 55 s. Other embodiments are contemplated wherein t4-t5 may be 55±10 s. According to embodiments t4-t5 may be 45-50 s, 50-55 s, 55-60 s or 60-65 s.

At the end of the fifth time period t4-t5 the controller may be configured to set a progressively higher target operating temperature. For example, after the end of the fifth time period t4-t5 the controller may be arranged to set a sixth target operating temperature T6 for the one or more aerosol generators. The sixth target operating temperature T6 may be 350° C. It will be understood that the sixth target operating temperature T6 is higher than the fifth target operating temperature T5. Other embodiments are contemplated wherein T6 may be 350±10° C. According to embodiments T6 may be 340-345° C., 345-350° C., 350-355° C. or 355-360° C. The controller may be configured to set the one or more aerosol generators a sixth target operating temperature T6 during a sixth time period t5-t6. The sixth time period t5-t6 may be 10 s. Other embodiments are contemplated wherein t5-t6 may be 10±5 s. According to embodiments t5-t6 may be 5-10 s or 10-15 s.

At the end of the sixth time period t5-t6 the controller may be configured to set a progressively higher target operating temperature. For example, after the end of the sixth time period t5-t6 the controller may be arranged to set a seventh target operating temperature T7 for the one or more aerosol generators. The seventh target operating temperature T7 may be 360° C. It will be understood that the seventh target operating temperature T7 is higher than the sixth target operating temperature T6. Other embodiments are contemplated wherein T7 may be 360±10° C. According to embodiments T7 may be 350-355° C., 355-360° C., 360-365° C. or 365-370° C. The controller may be configured to set the one or more aerosol generators a seventh target operating temperature T7 during a seventh time period t6-t7. The seventh time period t6-t7 may be 10 s. Other embodiments are contemplated wherein t6-t7 may be 10±5 s. According to embodiments t6-t7 may be 5-10 s or 10-15 s.

At the end of the seventh time period t6-t7 the controller may be configured to set a progressively higher target operating temperature. For example, after the end of the seventh time period t6-t7 the controller may be arranged to set an eighth target operating temperature T8 for the one or more aerosol generators. The eighth target operating temperature T8 may be 370° C. It will be understood that the eighth target operating temperature T8 is higher than the seventh target operating temperature T7. Other embodiments are contemplated wherein T8 may be 370±10° C. According to embodiments T8 may be 360-365° C., 365-370° C., 370-375° C. or 375-380° C. The controller may be configured to set the one or more aerosol generators an eighth target operating temperature T8 during an eighth time period t7-t8. The eighth time period t7-t8 may be 5 s. Other embodiments are contemplated wherein t7-t8 may be 5±2 s. According to embodiments t7-t8 may be 3-5 s or 5-7 s.

At the end of the eighth time period t7-t8 the controller may be configured to set a progressively higher target operating temperature. For example, after the end of the eighth time period t7-t8 the controller may be arranged to set a ninth target operating temperature T9 for the one or more aerosol generators. The ninth target operating temperature T9 may be 380° C. It will be understood that the ninth target operating temperature T9 is higher than the eighth target operating temperature T8. Other embodiments are contemplated wherein T9 may be 380±10° C. According to embodiments T9 may be 370-375° C., 375-380° C., 380-385° C. or 385-390° C. The controller may be configured to set the one or more aerosol generators a ninth target operating temperature T9 during a ninth time period t8-t9. The ninth time period t8-t9 may be 5 s. Other embodiments are contemplated wherein t8-t9 may be 5±2 s. According to embodiments t8-t9 may be 3-5 s or 5-7 s.

With reference to the heating profile shown in FIG. 7 and as described above the total aerosol generation session length may be 300 s i.e. the session of use may be arranged to end after a total time of 320 s wherein the aerosol provision device was ready for use after a ramp up time or time to first puff of 20 s (i.e. wherein time t0 to t_start was 20 s). It is noted that according to embodiments the maximum operating temperature set for the heater element may be approx. 380° C.

According to an alternative embodiment, the controller sets a heating profile similar to that of FIG. 7. The controller may be arranged so that a first target operating temperature T1 is achieved as quickly as possible thereby reducing the time to first puff.

| Profile Name | BASE ST7/20/300/GR Alternative | | |
|---|---|---|---|
| Time to first puff | 20 s | | |
| (ramp up time) | | | |
| Cumulative Time (s) | Profile Step | Step (s) | Heater temp ° C. |
| 70 | 1 | 70 | 370 |
| 125 | 2 | 55 | 375 |
| 180 | 3 | 55 | 380 |
| 235 | 4 | 55 | 385 |
| 290 | 5 | 55 | 390 |
| 300 | 6 | 10 | 400 |
| 310 | 7 | 10 | 410 |
| 315 | 8 | 5 | 420 |
| 320 | 9 | 5 | 430 |

The first target operating temperature T1 set by the controller may be 370° C. Other embodiments are contemplated wherein the first target operating temperature T1 may be 370±10° C. According to various embodiments the first target operating temperature T1 may be 360-365° C., 365-370° C., 370-375° C. or 375-380° C.

The second target operating temperature T2 may be 375° C. It will be understood that the second target operating temperature T2 is higher than the first target operating temperature T1. Other embodiments are contemplated wherein T2 may be 375±10° C. According to embodiments T2 may be 365-370° C., 370-375° C., 375-380° C. or 380-385° C.

The third target operating temperature T3 may be 380° C. It will be understood that the third target operating temperature T3 is higher than the second target operating temperature T2. Other embodiments are contemplated wherein T3 may be 380±10° C. According to embodiments T3 may be 370-375° C., 375-380° C., 380-385° C. or 385-390° C.

The fourth target operating temperature T4 may be 385° C. It will be understood that the fourth target operating temperature T4 is higher than the third target operating temperature T3. Other embodiments are contemplated wherein T4 may be 385±10° C. According to embodiments T4 may be 375-380° C., 380-385° C., 385-390° C. or 390-395° C.

The fifth target operating temperature T5 may be 390° C. It will be understood that the fifth target operating temperature T5 is higher than the fourth target operating temperature T4. Other embodiments are contemplated wherein T5 may be 390±10° C. According to embodiments T5 may be 380-385° C., 385-390° C., 390-395° C. or 395-400° C.

The sixth target operating temperature T6 may be 400° C. It will be understood that the sixth target operating temperature T6 is higher than the fifth target operating temperature T5. Other embodiments are contemplated wherein T6 may be 400±10° C. According to embodiments T6 may be 390-395° C., 395-400° C., 400-405° C. or 405-410° C.

The seventh target operating temperature T7 may be 410° C. It will be understood that the seventh target operating temperature T7 is higher than the sixth target operating temperature T6. Other embodiments are contemplated wherein T7 may be 410±10° C. According to embodiments T7 may be 400-405° C., 405-410° C., 410-415° C. or 415-420° C.

The eighth target operating temperature T8 may be 4200° C. It will be understood that the eighth target operating temperature T8 is higher than the seventh target operating temperature T7. Other embodiments are contemplated wherein T8 may be 420±10° C. According to embodiments T8 may be 410-415° C., 415-420° C., 420-425° C. or 425-430° C.

The ninth target operating temperature T9 may be 430° C. It will be understood that the ninth target operating temperature T9 is higher than the eighth target operating temperature T8. Other embodiments are contemplated wherein T9 may be 430±10° C. According to embodiments T9 may be 420-425° C., 425-430° C., 430-435° C. or 435-40° C.

The maximum operating temperature set for the heater element may be approx. 430° C.

Said embodiments are otherwise the same as that described with respect to FIG. 7.

FIG. 8 shows a heating profile according to an embodiment and illustrates a heating profile which may be set by a controller (e.g. controller 420 as shown in FIG. 5) for an aerosol generator when an aerosol provision device is operated in a second or boost mode of operation. The second or boost mode of operation may be arranged to have a shorter aerosol generation session time of e.g. 180 s (i.e. 3 mins). The overall session of use may last for 190 s i.e. the overall session of use may comprise a 10 s ramp up time followed by a 180 s aerosol generation session.

The heating profile has five progressive steps up in time whilst the temperature is maintained ≥360° C. during the course of a session of use. The aerosol provision device may comprise a pin-shaped heater element as described above with reference to FIGS. 3, 5 and 6 or a blade-shaped heater element. Alternatively, the heater element may comprise an inductive heater element i.e. the heater element may comprise heating material which is inductively heated by an RF generator.

According to various embodiments the controller may be arranged to control the heater element to heat to a first target operating temperature T1 during a first time period t0-t1, to heat to a second target operating temperature T2 during a second time period t1-t2, to heat to a third target operating temperature T3 during a third time period t2-t3, to heat to a fourth target operating temperature T4 during a fourth time period t3-t4 and to heat to a fifth target operating temperature T5 during a fifth time period t4-t5. The temperature of the heater element may be arranged to progressively increase during the progress of an aerosol generation session so that temperature T1<T2<T3<T4<T5. It will also be understood that time to <t1<t2<3<14<t5.

The aerosol provision device may comprise a temperature sensor for monitoring or sensing the temperature of the aerosol generator during the course of an aerosol generation session as described above.

Time t0 may correspond with the time that a controller initially activates or turns on the aerosol generator or e.g. supplies a current to the heater element. The heater element may be set a first target operating temperature T1 but it may take a few seconds before the heater element either achieves the first target operating temperature T1 or a lower temperature which is sufficiently in order to cause aerosol to be generated. This initial time may be referred to as the ramp up time or time to first puff. An aerosol generation session may be considered as commencing after the ramp up time or time to first puff at a time t_start wherein to <t_start<t1. The time to t_start may be e.g. 10-20 s. With regards the heating profile shown in FIG. 8, t_start is 10 s after time t0.

The controller may be configured so that a heating mode is performed wherein as the temperature is progressively stepped up the desired operating temperature which is set remains ≥360° C. For example, according to embodiments the lowest target operating temperature T1 which may be set for the heater element during a session of use may be arranged to be ≥360° C.

The specific heating profile shown in FIG. 8 relates to a second or boost mode of operation wherein a user is afforded a total aerosol generation session time of approx. 180 s (i.e. 3 mins). According to this particular embodiment the time from t0 to t_start is 10 s and the time from t_start to t5 (when the aerosol generator or heating element is switched OFF) is 180 s.

| Profile Name | BOOST BST1/10/180/GR | | |
|---|---|---|---|
| Time to first puff | 10 s | | |
| (ramp up time) | | | |
| Cumulative Time (s) | Profile Step | Step (s) | Heater temp ° C. |
| 80 | 1 | 80 | 360 |
| 110 | 2 | 30 | 365 |
| 140 | 3 | 30 | 370 |
| 170 | 4 | 30 | 375 |
| 190 | 5 | 20 | 380 |

When the controller sets a heating profile such as the heating profile shown in FIG. 8, the controller may be arranged to so that a first target operating temperature T1 is achieved as quickly as possible thereby reducing the time to first puff. For example, with reference to the heating profile shown in FIG. 8 the first target operating temperature T1 set by the controller may be 360° C. Other embodiments are contemplated wherein the first target operating temperature T1 may be 360±10° C. According to various embodiments the first target operating temperature T1 may be 350-355° C., 355-360° C., 360-365° C. or 365-370° C. The controller may be configured to set the heater element a first target operating temperature T1 during a first time period t0-t1. The first time period t0-t1 may be 80 s. Other embodiments are contemplated wherein t0-t1 may be 80±10 s. According to embodiments t0-t1 may be 70-75 s, 75-80 s, 80-85 s or 85-90 s.

A user may activate the aerosol provision device at a time to in order to cause the controller to set the one or more aerosol generators a desired heating profile. For example, a user may activate a user interface (see, for example, user interface 106 as shown in FIG. 1) provided on the aerosol provision device in order cause the one or more aerosol generators to set a desired heating profile for the one or more aerosol generators. Once a user has interacted with the user interface and the controller has set a desired heating profile for the one or more aerosol generators there may be a relatively short time delay (during time t0 to t_start) before the aerosol generator reaches a desired temperature and sufficient aerosol can be generated from an aerosol generating article at least partially inserted into the aerosol provision device. The time delay may be referred to as the ramp up time or time to first puff. As shown in FIG. 8, at the end of the ramp up time or once the time to first puff has passed (e.g. at time t_start) then an aerosol generation session may be considered as having commenced. In the case of the example shown in FIG. 8 the ramp up time or time to first puff (i.e. time t0 to t_start) is s. However, according to other embodiments the ramp up time or time to first puff may be shorter or longer than 10 s e.g. 5-10 s or 10-15 s.

With regards the heating profile shown in FIG. 8, the controller may set the one or more aerosol generators a first target temperature T1 for e.g. a 80 s period of time immediately upon a user activating the aerosol provision device. If the time to first puff or the ramp up time is 10 s, then it will be understood that the controller may be configured to maintain the desired first target operating temperature T1 of e.g. 360° C. for a further 70 s after the ramp up time or time to first puff has occurred. At the end of the first time period t0-t1 the controller may be configured to set progressively higher target operating temperatures. For example, after the end of the first time period t0-t1 the controller may be arranged to set a second target operating temperature T2 for the one or more aerosol generators. The second target operating temperature T2 may be 365° C. It will be understood that the second target operating temperature T2 is higher than the first target operating temperature T1. Other embodiments are contemplated wherein T2 may be 365±10° C. According to embodiments T2 may be 355-360° C., 360-365° C., 365-370° C. or 370-375° C. The controller may be configured to set the one or more aerosol generators the second target operating temperature T2 during a second time period t1-t2. The second time period t1-t2 may be 30 s. Other embodiments are contemplated wherein t1-t2 may be 30±10 s. According to embodiments t1-t2 may be 20-25 s, 25-30 s, 30-35 s or 35-40 s.

After the end of the second time period t1-t2 the controller may be arranged to set a progressively higher target operating temperature. For example, after the end of the second time period t1-t2 the controller may be arranged to set a third target operating temperature T3 for the one or more aerosol generators. The third target operating temperature T3 may be 370° C. It will be understood that the third target operating temperature T3 is higher than the second target operating temperature T2. Other embodiments are contemplated wherein T3 may be 370±10° C. According to embodiments T3 may be 360-365° C., 365-370° C., 370-375° C. or 375-380° C. The controller may be configured to set the one or more aerosol generators the third target operating temperature T3 during a third time period t2-t3. The third time period t2-t3 may be 30 s. Other embodiments are contemplated wherein t2-t3 may be 30±10 s. According to embodiments t2-t3 may be 20-25 s, 25-30 s, 30-35 s or 35-40 s.

At the end of the third time period t2-t3 the controller may be configured to set a yet further higher target operating temperature. For example, after the end of the third time period t2-t3 the controller may be arranged to set a fourth target operating temperature T4 for the one or more aerosol generators. The fourth target operating temperature T4 may be 375° C. It will be understood that the fourth target operating temperature T4 is higher than the third target operating temperature T3. Other embodiments are contemplated wherein T4 may be 375±10° C. According to embodiments T4 may be 365-370° C., 370-375° C., 375-380° C. or 380-385° C. The controller may be configured to set the one or more aerosol generators a fourth target operating temperature T4 during a fourth time period t3-t4. The fourth time period t3-t4 may be 30 s. Other embodiments are contemplated wherein t3-t4 may be 30±10 s. According to embodiments t3-t4 may be 20-25 s, 25-30 s, 30-35 s or 35-40 s.

At the end of the fourth time period t3-t4 the controller may be configured to set a progressively higher target operating temperature. For example, after the end of the fourth time period t3-t4 the controller may be arranged to set a fifth target operating temperature T5 for the one or more aerosol generators. The fifth target operating temperature T5 may be 380° C. It will be understood that the fifth target operating temperature T5 is higher than the fourth target operating temperature T4. Other embodiments are contemplated wherein T5 may be 380±10° C. According to embodiments T5 may be 370-375° C., 375-380° C., 380-385° C. or 385-390° C. The controller may be configured to set the one or more aerosol generators a fifth target operating temperature T5 during a fifth time period t4-t5. The fifth time period t4-t5 may be 20 s. Other embodiments are contemplated wherein t4-t5 may be 20±10 s. According to embodiments t4-t5 may be 10-15 s, 15-20 s, 20-25 s or 25-30 s.

According to an alternative embodiment of the second or boost mode of operation, the controller sets a heating profile similar to FIG. 8. The heating profile has four progressive steps up in time whilst the temperature is maintained ≥410° C. during the course of a session of use.

| Profile Name | BOOST BST1/10/180/GR Alternative | | |
|---|---|---|---|
| Time to first puff | 10 s | | |
| (ramp up time) | | | |
| Cumulative Time (s) | Profile Step | Step (s) | Heater temp ° C. |
| 80 | 1 | 80 | 410 |
| 110 | 2 | 30 | 415 |
| 140 | 3 | 30 | 420 |
| 170 | 4 | 30 | 425 |
| 190 | 5 | 20 | 430 |

The first target operating temperature T1 set by the controller may be 410° C. Other embodiments are contemplated wherein the first target operating temperature T1 may be 410±10° C. According to various embodiments the first target operating temperature T1 may be 400-405° C., 405-410° C., 410-415° C. or 415-420° C.

The second target operating temperature T2 may be 415° C. It will be understood that the second target operating temperature T2 is higher than the first target operating temperature T1. Other embodiments are contemplated wherein T2 may be 415±10° C. According to embodiments T2 may be 405-410° C., 410-415° C., 415-420° C. or 420-425° C.

The third target operating temperature T3 may be 420° C. It will be understood that the third target operating temperature T3 is higher than the second target operating temperature T2. Other embodiments are contemplated wherein T3 may be 420±10° C. According to embodiments T3 may be 410-415° C., 415-420° C., 420-425° C.

The fourth target operating temperature T4 may be 425° C. It will be understood that the fourth target operating temperature T4 is higher than the third target operating temperature T3. Other embodiments are contemplated wherein T4 may be 410±10° C. According to embodiments T4 may be 400-405° C., 405-410° C., 410-415° C. or 415-420° C.

The fifth target operating temperature T5 may be 430° C. It will be understood that the fifth target operating temperature T5 is higher than the third target operating temperature T4. Other embodiments are contemplated wherein T5 may be 430±10° C. According to embodiments T5 may be 420-425° C., 425-430° C., 430-435° C. or 435-440° C.

The maximum operating temperature set for the heater element may be approx. 430° C.

Said embodiments are otherwise the same as that described with respect to FIG. 8.

With reference to the heating profile shown in FIG. 8 and as described above the total aerosol generation session length may be 180 s i.e. the session of use may be arranged to end after a total session of use length of 190 s wherein the aerosol provision device was ready for use after a ramp up time or time to first puff of 10 s (i.e. wherein time t0 to t_start was 10 s). It is noted that according to embodiments the maximum operating temperature set for the heater element may be approx. 380° C.

It should be understood that numerous different heating profiles were tested but that only a few heating profiles were selected and are disclosed in the present application. An initial screening of the different heating profiles was performed by making an initial assessment on sensory attributes such as visible aerosol generation, the feeling on the mouth, the sensation at the back of the throat (i.e. impact), taste quality and whether or not there any off notes were detected.

Heating profiles which resulted in either a good or excellent overall sensory experience were then subjected to more detailed testing. The various different heating profiles which are shown and described above with reference to FIGS. 7, 8, 11 and 12 were found during the initial screening process to result in an excellent overall sensory experience. The heating profiles were then further tested by a panel of 6-10 users and the sensory experience was assessed using a sequential monadic testing methodology involving taking 10 puffs during the course of a session. The specific heating profiles as shown and described with reference to FIGS. 7, 8, 11 and 12 were all found to result in an excellent overall sensory experience.

A common feature of the heating profiles as disclosed with reference to FIGS. 7 and 8 is that the target operating temperature of the one or more aerosol generators or heater elements progressively increases during the course of a session of use.

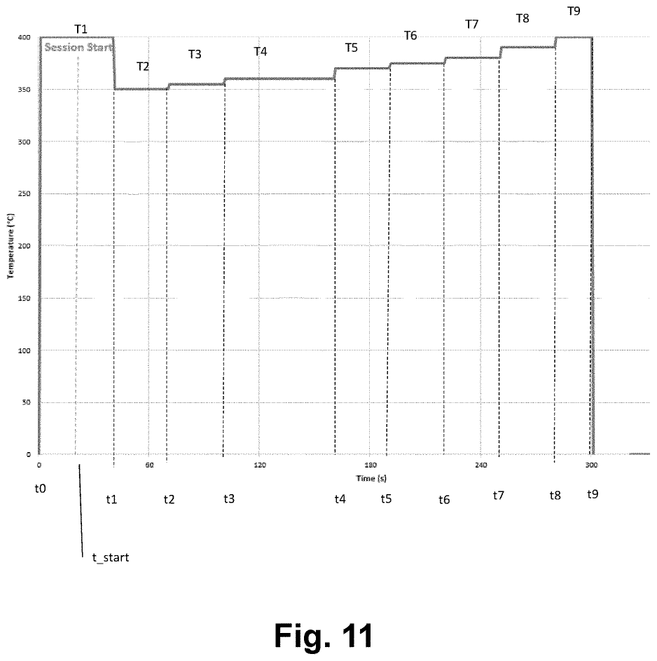

A feature of the heating profile as disclosed with reference to FIG. 11 is that the target operating temperature of the one or more aerosol generators or heater elements decreases once, then progressively increases during the course of a session of use.

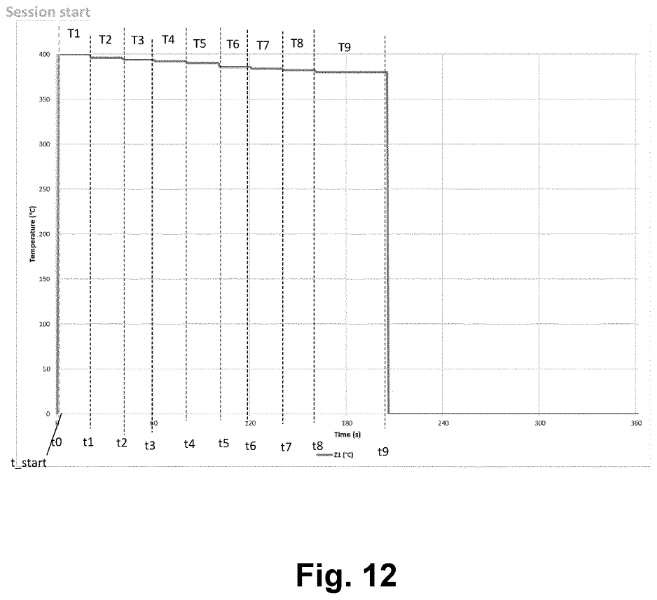

A feature of the heating profile as disclosed with reference to FIG. 12 is that the target operating temperature of the one or more aerosol generators or heater elements progressively decreases during the course of a session of use.

The various heating profiles which are disclosed in the present application have been found to provide a sensory experience wherein taste quality is preserved/prolonged throughout the whole of an aerosol generation session.

The heating profiles shown and described above with reference to FIGS. 7, 8, 11 and 12 were assessed by the panel of users in order to assess sixteen different sensory attributes. Six of the sensory attributes related to “immediacy” and were assessed after the first two puffs in a session. These sensory attributes were draw resistance, aerosol warmth, visible aerosol, impact, irritation and flavour amplitude. A further ten sensory attributes relating to “overall experience” were assessed after taking 10 puffs during the course of a session of use. These attributes were draw resistance, aerosol warmth, visible aerosol, impact, irritation, tobacco taste intensity, flavour amplitude, overall flavour intensity, off taste and flavour consistency. The sensory testing confirmed that the two heating profiles shown and described with reference to FIGS. 7,8 and 11 resulted in an excellent sensory experience.

In embodiments wherein the one or more aerosol generators are operable in at least a first mode and a second mode, the first (base) and (second) boost modes may be selected to provide distinct sensory experiences. This is to provide the user with different overall experiences in the different modes of operation.

For example, a heating profile wherein the target operating temperature of the one or more aerosol generators or heater elements decreases once, then progressively increases during the course of a session of use, such as that described with respect to FIG. 11, may be used as a first (base) mode of operation, and a heating profile target operating temperature of the one or more aerosol generators or heater elements progressively decreases during the course of a session of use, such as that described with respect to FIG. 12, may be used as a second (boost) mode of operation.

It should be understood that various alternative heating profiles which were assessed either to result in an average or poor sensory experience were rejected and details of the rejected heating profiles have not been included in the present application.

For example, some heating profiles having desired operating temperatures below 300° C. were rejected since aerosol formation was observed either to be incomplete or non-existent. Equally, some heating profiles having desired operating temperatures in excess of 400° C. were rejected as causing charring and/or burning of the aerosol generating article. It is noted that both the heating profiles disclosed herein have a relatively high maximum operating temperature of 380° C. However, the heater element is only maintained at the maximum desired operating temperature for a relatively short period of time towards the end of an aerosol generation session.

Also, it was found that the total length of aerosol generation sessions utilising some heating profiles which were tested were found to result in an unacceptably short total aerosol generation session time. For example, some heating profiles were found to result in the aerosol generating article being consumed after approx. 2 mins. Accordingly, even if a heating profile was found to result in a good sensory experience it was rejected if the maximum aerosol generating session time was too short. Similarly, heating profiles which resulted in an unacceptably slow time to first puff were also rejected. With the two heating profiles shown and described above with reference to FIGS. 7 and 8 it is noted that there is an inverse correlation between the first target operating temperature T1 and the time to first puff. For example, with the heating profile shown in FIG. 7 the time to first puff is 20 s and the first target operating temperature T1 was 320° C. With the heating profile shown in FIG. 8 the time to first puff was 10 s and the first target operating temperature T1 was 360° C.

A further criteria for selecting or rejecting a heating profile is that it is desired that an aerosol provision device should be provided which is operable in at least two different modes which provide a user with two (or more) different sensory experiences. Accordingly, heating profiles were also selected or rejected on the basis of providing a differentiated sensory experience. Heating profiles which were not found to provide a differentiated sensory experience were rejected.

Other factors which influenced whether or not a heating profile was selected or rejected was MNPH (whole aerosol) analysis and puff by puff emission testing. The various heating profiles shown and described with reference to FIGS. 7, 8, 11 and 12 were found not to result in an undesirable hot puff and the temperature of the aerosol provision device in the hand of the user was found to be within acceptable safety limits. The various heating profiles shown and described with reference to FIGS. 7, 8, 11 and 12 were also found not to be overly draining on the battery of the aerosol provision device so that the aerosol provision device was able to perform multiple aerosol generation sessions before needing to be charged. The various heating profiles shown and described with reference to FIGS. 78, 11 and 12 were also found not to cause the generation of any undesired carbonyls or potential toxicants. The heating profiles as described above with reference to FIGS. 7, 8, 11 and 12 were also found not to generate an undesirable amount of condensate.

According to various embodiments after the ramp time t_start and/or when the aerosol generator or heating element has reached a first target operating temperature T1, one or more indicator devices may indicate to the user that the aerosol provision device is ready for use. For example, the indicator device may comprise one or more light emitting diodes (LEDs) provided on a user interface of the aerosol provision device. The number of LEDs illuminated and/or the colour of one or illuminated LEDs and/or the intensity of one or more illuminated LEDs may indicate to a user when the aerosol provision device is ready for use. Additionally or alternatively, the indicator device may comprise a haptic feedback device. Embodiments are also contemplated wherein the indicator device may additionally or alternatively comprise an audible indicator device. One or more indicator devices as described above may also indicate to a user when an aerosol generation session has been completed.

As will be discussed in more detail below with reference to FIG. 9, embodiments are contemplated wherein an aerosol generating article having a flavour capsule may be heated by an aerosol provision device according to various embodiments as described above, wherein the aerosol provision device may be operated in either a first heating mode of operation (as shown and described, for example, with reference to FIGS. 7 and 11) or in a second heating mode of operation (as shown and described, for example, with reference to FIGS. 8 and 12). Embodiments are contemplated wherein the first heating mode of operation provides an optimum sensory experience when the flavour capsule is not fragmented and the second heating mode of operation provides an optimum sensory experience when the flavour capsule is fragmented. Other embodiments are contemplated wherein the first heating mode provides an optimum sensory experience when the flavour capsule is fragmented and the second heating mode provides an optimum sensory experience when the flavour capsule is not fragmented.

According to embodiments the aerosol provision device may comprise a first aerosol generator comprising a first heater element and a second aerosol generator comprising a second heater element. The first heater element may be provided so as to form a first heating zone which may heat a first portion of an aerosol generating article and the second heater element may be provided so as to form a second heating zone which may heat a second portion of the aerosol generating article.

For completeness, it should be understood that the various heating profiles shown and described above with reference to FIGS. 7,8, 9 and 11 are particularly suitable when the controller is arranged to control the heating profile of a pin-shaped heater element (or a blade-shaped heater element) which is configured to heat an aerosol generating article comprising a plurality of different sections or portions. The aerosol generating article may, in particular, comprise a cylindrical article comprising e.g. a cylindrical portion of aerosol generating material provided in a distal portion of the article. The cylindrical portion of aerosol generating material may have a diameter of approx. 7.0 mm and a length of 12.0 mm. Upstream of the cylindrical portion of aerosol generating material may be provided a first tubular element having a length of about 7 mm and an outer diameter of approx. 7.0 mm. Upstream of the first tubular element a second tubular element may be provided having a length of about 17 mm and an outer diameter of approx. 7 mm. The cylindrical portion of aerosol generating material, the first tubular element and the second tubular element may be wrapped in one or more outer wrappings which may have a total thickness of approx. 200 μm.

FIG. 9 shows a side-on cross sectional view of an aerosol generating article 1001 which may be utilised with an aerosol provision device 1003 comprising a pin-shaped heater element 1002a as discussed in more detail above according to various embodiments. The pin-shaped heater element 1002a may be controlled by a controller (not shown) and according to various embodiments a heating profile as shown and described above in relation to FIGS. 7,8, 11 and 12 may be set for the heater element 1002a. In particular, the heater element 1002a may be operated in a first or base mode of operation so that a heating profile as shown in FIG. 7 may be set for the pin-shaped heater element 1002a according to an embodiment. As discussed above, the heating profile may comprise a series of nine steps up during the course of a session of use. The temperature set for the heater element 1002a may be maintained ≥320° C. throughout a session of use. According to other embodiments the heater element 1002a may be operated in a second or boost mode of operation so that a heating profile as shown in FIG. 8 may be set for the pin-shaped heater element 1002a. As discussed above, the heating profile may have a profile comprising a series of five steps up during the course of a session of use. The temperature set for the heater element 1002a may be maintained >360° C. throughout a session of use. It is noted that whereas a first or base mode of operation may enable a user to experience an aerosol generation session which lasts for approx. 300 s after the initial time to first puff (t_start), the second or boost mode of operation may enable a user to experience a different sensory experience wherein an aerosol generation session lasts for a shorter period of time e.g. 180 s after the initial time to first puff (t_start). The different sensory experience is in part achieved by ensuring that the average temperature set for the heater element 1002a during the second or boost mode of operation is higher than the average temperature set for the heater element 1002a during the first or base mode of operation.

The aerosol generating article 1001 may comprise an aerosol generating section 1004 which in use may be inserted into a receiving portion 1002 of an aerosol provision device 1003. The receiving portion 1002 may comprise a recess in the aerosol provision device 1003. The aerosol provision device 1003 may comprise one or more aerosol generators such as a pin-shaped heater 1002a. The pin-shaped heater 1002a may be located within the receiving portion 1002 of the aerosol provision device 1003 and the pin-shaped heater may be arranged to penetrate the aerosol generating section 1004 of the aerosol generating article 1001 as the aerosol generating article 1001 is inserted, in use, into the aerosol provision device 1003. The pin-shaped heater 1002a may be resistively heated and may comprise a resistive heater element. However, alternative embodiments are contemplated wherein the heater element 1002a may comprise a blade-shaped heater element. Further embodiments are contemplated wherein the aerosol generator may comprise a heater element formed of a heating material which may be inductively heated and may comprise a susceptor element. A magnetic field generator may be provided which is arranged to induce an alternating electric current in the susceptor element thereby causing heating of the susceptor element. Yet further embodiments are contemplated wherein the aerosol generating section 1004 of the aerosol generating article 1001 may comprise a heating material which may be inductively heated i.e. the article may comprise a susceptor element. For example, according to embodiments the pin-shaped heater element 1002a may be omitted and a susceptor element comprising heating material may be located in the aerosol generating section 1004. According to embodiments a bi-layered susceptor element comprising e.g. a stainless steel layer and a nickel coating layer may be provided.

The article 1001 may comprise a downstream section 1005 downstream of the aerosol generating section 1004. The downstream section 1005 may comprise or may include a mouthpiece designed to be inserted into a user's mouth in use. The downstream section 1005 may comprise an upstream end 1005a and a downstream end 1005b. The aerosol generating section 1004 may comprise a source of aerosol generating material in the form of a cylindrical rod of aerosol generating material. In other examples, the aerosol generating section 1004 may comprise a cavity for receiving a source of aerosol generating material. The aerosol generating material may include at least 5% of an aerosol-former material by weight of the aerosol generating material, calculated on a dry weight basis. The aerosol aerosol-former material may, for example, comprise glycerol or propylene glycol.

The mouthpiece or downstream portion 1005 may include a first tubular element 1008a arranged immediately downstream of the aerosol generating section 1004. The first tubular element 1008a may define a first hollow cavity. The first tubular element 1008a may be in an abutting relationship with the aerosol generating section 1004. The first tubular element 1008a may have a first tubular wall. The mouthpiece or downstream portion 1005 may also include a second tubular element 1008b immediately downstream of the first tubular element 1008a. The second tubular element 1008b may be in an abutting relationship with the first tubular element 1008a. The second tubular element 1008b may have a second tubular wall having a wall thickness of less than about 320 μm. The second tubular element 1008b may have an axial length of 15-25 mm, for example 17 mm. A body of material 1006 may be provided at the downstream end 1005b of the downstream section 1005. The first and second tubular elements 1008a, 1008b and the body of material 1006 may each define a cylindrical outer shape and may be arranged end-to-end on a common axis. The first and second tubular elements 1008a, 1008b, the aerosol generating section 1004 and the body of material 1006 may be arranged to have approximately the same outer diameter.

The first and second tubular elements 1008a, 1008b together may define a chamber into which aerosol formed in the aerosol generating section 1004 is drawn and expands and cools. The provision of discrete first and second tubular elements 1008a, 1008b enables these components to be designed to achieve different functional effects. For instance, the first tubular element 1008a may be effective in reducing movement of the aerosol generating material when the article 1001 is inserted into the recess 1002 and on to the pin-shaped heater element 1002a. For this purpose, the first tubular element 1008a may have a wall thickness of 1.0-3.5 mm e.g. 1.5-2.5 mm. The first tubular element 1008a may assist with providing rigidity to the article 1001. The first tubular element 1008a may also be arranged to encourage aerosol to flow predominantly through an axial region of the second tubular element 1008b in order to assist with aerosol formation. By contrast, the second tubular element 1008b may be arranged to define a relatively large chamber as compared to the first tubular element 1008a thereby providing a greater space into which the aerosol formed in the aerosol generating section 1004 can be drawn into so that the aerosol expands and cools.

The aerosol generating article 1001 may have a circumference of 22.1 mm corresponding to a diameter of 7.0 mm. The aerosol generating section 1004 may have a length of 12.0 mm, the first tubular element 1008a may have a length of 7.0 mm and the second tubular element may have a length of 17.0 mm. According to various embodiments aerosol generating material provided in the aerosol generating section 1004 may comprise a plurality of strands or strips of aerosol generating material. The strands or strips of aerosol generating material may be arranged such that their longitudinal dimension is substantially parallel with the longitudinal axis of the aerosol generating article 1003. The aerosol generating material may be in the form of reconstituted sheet tobacco material, such as bandcast reconstituted tobacco. The wall of the second tubular element 1008b may comprise first and second overlapping paper layers each extending around substantially the whole circumference of the second tubular element 1008b. The first and second overlapping paper layers may each have a thickness of 30-150 μm. The aerosol provision device 1003 may comprise a housing 1009 and an aperture 1010 in the housing 1009 into which the article 1001 may be inserted in use. When the article 1001 is fully inserted into the aerosol provision device 1003, the second tubular element 1008b may extend at least about 5 mm within and at least 8 mm beyond the housing 1009. The article 1001 may be inserted into the aerosol provision device 1003 to an insertion depth of about 25 mm, as shown by arrow ‘B’ in FIG. 9.

It will be understood by those skilled in the art that bandcast reconstituted tobacco has a relatively high density. It is noted that the various heating profiles as disclosed above with reference to FIGS. 7 and 8 have a relatively high maximum target operating temperature and also a relatively high minimum target operating temperature.

Over the course of a session of use, the heating profiles as discussed above with reference to FIGS. 7 and 8 may have an average target operating temperature ≥320° C. The relatively high target operating temperatures are particularly suitable for generating aerosol from an article comprising bandcast reconstituted tobacco.

The article 1001 may comprise one or more ventilation apertures 1012 extending through the second tubular element 1008b at a location in the second tubular element 1008b which is outside the housing 1009 when the article 1001 is fully inserted into the aerosol provision device 1003. The one or more ventilation apertures 1012 may be provided as one or more rows of apertures, such as laser or mechanically formed perforations, circumscribing the article 1001.

The cylindrical rod of aerosol generating material may comprise a plurality of strands and/or strips of aerosol generating material which are circumscribed by a wrapper 1015. The wrapper 1015 may be a moisture impermeable wrapper. The plurality of strands or strips of aerosol generating material may be aligned within the aerosol generating section 1004 such that their longitudinal dimension is in parallel alignment with the longitudinal axis, X-X′ of the article 1001. Alternatively, the strands or strips may generally be arranged such that their longitudinal dimension aligned is transverse to the longitudinal axis of the article 1001. Where the majority of the strands or strips are arranged in the aerosol generating section 1004 such that their longitudinal axis is parallel with the longitudinal axis of the aerosol generating section 1004 of the article 1001, the force required to insert an aerosol generator, such as a heater element 1002a into the aerosol generating material may be relatively low. This can result in an article 1001 which is easier to use.

The rod of aerosol generating material may have a circumference of about 22.1 mm (corresponding to a diameter of 7.0 mm). The first tubular element 1008a may be formed from filamentary tow such as plasticised cellulose acetate tow. The wall of the first tubular element 1008a may be relatively non-porous, such that at least 80% of the aerosol generated by the aerosol generating material passes longitudinally through the hollow channels through the tube rather than through the wall material itself. The first and second tubular elements 1008a, 1008b may be configured to provide a temperature differential of at least 40° C. between a heated volatilised component entering a first upstream end of the first and second tubular elements 1008a, 1008b and a heated volatilised component exiting a second downstream end of the first and second tubular elements 1008a, 1008b. This temperature differential across the length of the first and second tubular elements 1008a, 1008b may protect a temperature sensitive body of material 1006 from the high temperatures of the aerosol generating material when it is heated.

The moisture impermeable wrapper 1015 which circumscribes the rod of aerosol generating material may comprise aluminium foil. The body of material 1006 may be wrapped in a first plug wrap 1007. A second plug wrap 1013 may be provided to connect the body of material 1006, the first tubular element 1008a and second tubular element 1008b. The length of the body of material 1006 may be less than about 15 mm e.g. 12 mm. The body of material 1006 may be formed from filamentary tow. For example, the tow may comprise plasticised cellulose acetate tow or polylactic acid (PLA).

As shown in FIG. 10 a tipping paper 1016 may be wrapped around the full length of the downstream portion 1005 and over part of the rod of aerosol generating material. The tipping paper 1016 may have an adhesive on its inner surface to connect the downstream portion 1005 and the rod of aerosol generating material. The rod of aerosol generating material may be wrapped in a wrapper 1015, which forms a first wrapping material, and the tipping paper 1016 may form an outer wrapping material which extends at least partially over the rod of aerosol generating material to connect the downstream portion 1005 and the rod of aerosol generating material. The tipping paper 1016 may extend 5 mm over the rod of aerosol generating material to provide a secure attachment. The article 1001 may have a ventilation level of about 25% of the aerosol drawn through the article 1001. The article 1001 may include ventilation apertures provided into the second tubular element 1008b. A second hollow cavity defined by the second tubular element 1008b may have a diameter of about 6.6 mm and a radius ‘r’ as shown in FIG. 10 of about 3.3 mm.

An aerosol modifying agent may be provided within the body of material 1006 in the form of an additive release component. As shown in FIG. 9, the additive release component may comprise a capsule 1011. However, it should be understood that the capsule 1011 is optional and may be omitted according to various embodiments. If the article 1003 comprises a capsule 1011 then the first plug wrap 1007 may comprise an oil-resistant first plug wrap 1007. The capsule 1011 may comprise a breakable capsule i.e. a solid frangible shell surrounding a liquid payload. The capsule 1011 may comprise a shell encapsulating a liquid agent such as a flavourant or other agent. The shell of the capsule 1011 may be ruptured by a user to release the flavourant or other agent into the body of material 1006. The capsule 1011 may be spherical and may have a diameter of about 3 mm. The aerosol generating material may comprise an aerosol-former material. The aerosol-former material may comprise, for example, glycerol or propylene glycol. The aerosol generating material may comprise an aerosol modifying agent such as menthol.

The specific heating profile shown in FIG. 11 relates to a base or standard mode of operation wherein a user is afforded a total aerosol generation session time of approx. 300 s (i.e. 5 mins). According to this particular embodiment the time from t0 to t_start is 20 s and the time from t_start to t9 (when the aerosol generator or heating element is switched OFF) is 300 s.

| Profile Name | BASE ST7/20/300/GR | | |
|---|---|---|---|
| Time to first puff | 20 s | | |
| (ramp up time) | | | |
| Cumulative Time (s) | Profile Step | Step (s) | Heater temp ° C. |
| 40 | 1 | 40 | 400 |
| 70 | 2 | 30 | 350 |
| 100 | 3 | 30 | 355 |
| 160 | 4 | 60 | 360 |
| 200 | 5 | 40 | 370 |
| 220 | 6 | 20 | 375 |
| 250 | 7 | 30 | 380 |
| 280 | 8 | 30 | 390 |
| 300 | 9 | 20 | 400 |

When the controller sets a heating profile such as the heating profile shown in FIG. 11, the controller may be arranged so that a first target operating temperature T1 is achieved as quickly as possible thereby reducing the time to first puff. In the example of FIG. 11, the first target operating temperature T1 set by the controller is 400° C. In other embodiments, the first target operating temperature T1 may be 400±10° C. According to various embodiments the first target operating temperature T1 may be 390-395° C., 395*400° C., 400-405° C. or 405-410° C. The controller is configured to set the heater element a first target operating temperature T1 during a first time period t0-t1. The first time period t0-t1 may be 40 s. In other embodiments, t0-t1 may be 400±10 s. According to embodiments t0-t1 may be 30-35 s, 35-40 s, 40-45 s, 45-50 s,

A user may activate the aerosol provision device at a time to in order to cause the controller to set the one or more aerosol generators a desired heating profile (for example, user interface 106 as shown in FIG. 1). Once a user has interacted with the user interface and the controller has set a desired heating profile for the one or more aerosol generators there may be a relatively short time delay (during time t0 to t_start) before the aerosol generator reaches a desired operating temperature and sufficient aerosol can be generated from an aerosol generating article at least partially inserted into the aerosol provision device. The time delay may be referred to as the ramp up time or time to first puff. In the case of the example shown in FIG. 11, the ramp up time or time to first puff (i.e. time t0 to t_start) is 20 s. In other embodiments the ramp up time may be shorter or longer than 20 s e.g. 10-15 s, 15-20 s, 20-25 s or 25-30 s.

In the profile of FIG. 11, the controller sets the one or more aerosol generators a first target temperature T1 which is 40 s At the end of the first time period t0-t1 the controller is configured to set a second target temperature T2, which is a step down, in other words second target operating temperature T2 is lower than the first target operating temperature T1. In the example of FIG. 11 is T2 350° C. In other embodiments, the first target operating temperature T1 may be 350±10° C. According to embodiments T2 may be 340-345° C., 345-350° C., 350-355° C. or 355-350° C. The controller may be configured to set the one or more aerosol generators the second target operating temperature T2 during a second time period t1-t2. The second time period t1-t2 may be 30 s. Other embodiments are contemplated wherein t1-t2 may be 30±10 s. According to embodiments t1-t2 may be 20-25 s, 25-30 s, 30-35 s or 35-40 s.

After the end of the second time period t1-t2 the controller is configured to set a progressively higher target operating temperature. After the end of the second time period t1-t2 the controller is configured to set a third target operating temperature T3 for the one or more aerosol generators. The third target operating temperature T3 may be 355° C. It will be understood that the third target operating temperature T3 is higher than the second target operating temperature T2. In other embodiments, T3 may be 355±10° C. According to embodiments T3 may be 345-350° C., 35-355° C., 355-360° C. or 360-365° C. The controller may be configured to set the one or more aerosol generators the third target operating temperature T3 during a third time period t2-t3. The third time period t2-t3 may be 30 s. Other embodiments are contemplated wherein t2-t3 may be 30±10 s. According to embodiments t1-t2 may be 20-25 s, 25-30 s, 30-35 s or 35-40 s.

At the end of the third time period t2-t3 the controller may be configured to set a progressively higher target operating temperature. For example, after the end of the third time period t2-t3 the controller may be arranged to set a fourth target operating temperature T4 for the one or more aerosol generators. The fourth target operating temperature T4 may be 360° C. It will be understood that the fourth target operating temperature T4 is higher than the third target operating temperature T3. Other embodiments are contemplated wherein T4 may be 360±10° C. According to embodiments T4 may be 350-355° C., 355-360° C., 360-365° C. or 365-370° C. The controller may be configured to set the one or more aerosol generators a fourth target operating temperature T4 during a fourth time period t3-t4. The fourth time period t3-t4 may be 55 s. Other embodiments are contemplated wherein t3-t4 may be 60±10 s. According to embodiments t3-t4 may be 50-55 s, 55-60 s, 60-65 s or 65-70 s.

At the end of the fourth time period t3-t4 the controller may be configured to set a progressively higher target operating temperature. For example, after the end of the fourth time period t3-t4 the controller may be arranged to set a fifth target operating temperature T5 for the one or more aerosol generators. The fifth target operating temperature T5 may be 370° C. It will be understood that the fifth target operating temperature T5 is higher than the fourth target operating temperature T4. Other embodiments are contemplated wherein T5 may be 370±10° C. According to embodiments T5 may be 360-365° C., 365-370° C., 370-375° C. or 375-380 s. ⁸⁰° C. The controller may be configured to set the one or more aerosol generators a fifth target operating temperature T5 during a fifth time period t4-t5. The fifth time period t4-t5 may be 40 s. Other embodiments are contemplated wherein t4-t5 may be 40±10 s. According to embodiments t4-t5 may be 30-35 s, 35-40 s, 40-45 s or 45-50 s.

At the end of the fifth time period t4-t5 the controller may be configured to set a progressively higher target operating temperature. For example, after the end of the fifth time period t4-t5 the controller may be arranged to set a sixth target operating temperature T6 for the one or more aerosol generators. The sixth target operating temperature T6 may be 375° C. It will be understood that the sixth target operating temperature T6 is higher than the fifth target operating temperature T5. Other embodiments are contemplated wherein T6 may be 375±10° C. According to embodiments T6 may be 365-370° C., 370-375° C., 375-380 s or 380-385° C. The controller may be configured to set the one or more aerosol generators a sixth target operating temperature T6 during a sixth time period t5-t6. The sixth time period t5-t6 may be 20 s. Other embodiments are contemplated wherein t5-t6 may be 20±10 s. According to embodiments t5-t6 may be 10-15 s, 15-20 s, 20-25 s, 25-30 s.

At the end of the sixth time period t5-t6 the controller may be configured to set a progressively higher target operating temperature. For example, after the end of the sixth time period t5-t6 the controller may be arranged to set a seventh target operating temperature T7 for the one or more aerosol generators. The seventh target operating temperature T7 may be 380° C. It will be understood that the seventh target operating temperature T7 is higher than the sixth target operating temperature T6. Other embodiments are contemplated wherein T7 may be 380±10° C. According to embodiments T7 may be, 370-375° C., 375-380 s, 380-385° C. or 385-390° C. The controller may be configured to set the one or more aerosol generators a seventh target operating temperature T7 during a seventh time period t6-t7. The seventh time period t6-t7 may be 30 s. Other embodiments are contemplated wherein t6-t7 may be 30±10 s. According to embodiments t6-t7 may be 20-25 s, 25-30 s, 30-35 s or 35-40 s.

At the end of the seventh time period t6-t7 the controller may be configured to set a progressively higher target operating temperature. For example, after the end of the seventh time period t6-t7 the controller may be arranged to set an eighth target operating temperature T8 for the one or more aerosol generators. The eighth target operating temperature T8 may be 390° C. It will be understood that the eighth target operating temperature T8 is higher than the seventh target operating temperature T7. Other embodiments are contemplated wherein T8 may be 390±10° C. According to embodiments T8 may be 380-385° C. or 385-390° C.·390-395° C. or 395-400° C. The controller may be configured to set the one or more aerosol generators an eighth target operating temperature T8 during an eighth time period t7-t8. The eighth time period t7-t8 may be 30 s. Other embodiments are contemplated wherein t7-t8 may be 30±10 s. According to embodiments t7-t8 may be 20-25 s, 25-30 s, 30-35 s or 35-40 s.

At the end of the eighth time period t7-t8 the controller may be configured to set a progressively higher target operating temperature. For example, after the end of the eighth time period t7-t8 the controller may be arranged to set a ninth target operating temperature T9 for the one or more aerosol generators. The ninth target operating temperature T9 may be 40° C. It will be understood that the ninth target operating temperature T9 is higher than the eighth target operating temperature T8. Other embodiments are contemplated wherein T9 may be 400±10° C. According to embodiments T9 may be 390-395° C., 395-400° C., 400-405° C. or 405-410° C. The controller may be configured to set the one or more aerosol generators a ninth target operating temperature T9 during a ninth time period t8-t9. The ninth time period t8-t9 may be 20 s. Other embodiments are contemplated wherein t8-t9 may be 20±10 s. According to embodiments t8-t9 may be 10-15 s, 15-20 s, 20-25 s, 25-30 s.

With reference to the heating profile shown in FIG. 11 and as described above the total aerosol generation session length may be 300 s i.e. the session of use may be arranged to end after a total time of 320 s wherein the aerosol provision device was ready for use after a ramp up time or time to first puff of 20 s (i.e. wherein time t0 to t_start was 20 s). It is noted that according to embodiments the maximum operating temperature set for the heater element may be approx. 400° C.

The specific heating profile shown in FIG. 12 relates to a boost mode of operation wherein a user is afforded a total aerosol generation session time of approx. 180 s (i.e. 3 mins). According to this particular embodiment the time from t0 to t_start is 15 s and the time from t_start to t9 (when the aerosol generator or heating element is switched OFF) is 180 s.

| Profile Name | BOOST BST15-15-190-GD | | |
|---|---|---|---|
| Time to first puff | 15 s | | |
| (ramp up time) | | | |
| Cumulative time (s) | Profile step | Step (s) | Blade temp ° C. |
| 20 | 1 | 20 | 400 |
| 40 | 2 | 20 | 396 |
| 60 | 3 | 20 | 394 |
| 80 | 4 | 20 | 392 |
| 100 | 5 | 20 | 390 |
| 120 | 6 | 20 | 386 |
| 140 | 7 | \|20 | 384 |
| 160 | 8 | 20 | 382 |
| 180 | 9 | 20 | 380 |

When the controller sets a heating profile such as the heating profile shown in FIG. 12, the controller may be arranged to so that a first target operating temperature T1 is achieved as quickly as possible thereby reducing the time to first puff. For example, with reference to the heating profile shown in FIG. 12 the first target operating temperature T1 set by the controller is 400° C. In other embodiments, the first target operating temperature T1 may be 400±10° C. According to various embodiments the first target operating temperature T1 may be 390-395° C., 395-400° C., 400-405° C. or 405-410° C. The controller may be configured to set the heater element a first target operating temperature T1 during a first time period t0-t1. The first time period t0-t1 may be 20 s. Other embodiments are contemplated wherein t0-t1 may be 20±10 s. According to embodiments t0-t1 may be 10-15 s, 15-20 s, 20-25 s or 25-30 s.

A user may activate the aerosol provision device at a time to in order to cause the controller to set the one or more aerosol generators a desired heating profile (see, for example, user interface 106 as shown in FIG. 1). Once a user has interacted with the user interface and the controller has set a desired heating profile for the one or more aerosol generators there may be a relatively short time delay (during time t0 to t_start) before the aerosol generator reaches a desired temperature and sufficient aerosol can be generated from an aerosol generating article at least partially inserted into the aerosol provision device. The time delay may be referred to as the ramp up time or time to first puff. As shown in FIG. 12, at the end of the ramp up time or once the time to first puff has passed (e.g. at time t_start) then an aerosol generation session may be considered as having commenced. In the case of the example shown in FIG. 8 the ramp up time or time to first puff (i.e. time t0 to t_start) is 15 s. However, according to other embodiments the ramp up time or time to first puff may be shorter or longer than 15 s e.g. 5-10 s, 10-15 s, 15-20 s or 20-25 s.

With regards the heating profile shown in FIG. 12, the controller may set the one or more aerosol generators a first target temperature T1 for e.g. a 20 s period of time immediately upon a user activating the aerosol provision device. If the time to first puff or the ramp up time is 15 s, then it will be understood that the controller may be configured to maintain the desired first target operating temperature T1 of e.g. 400° C. for a further 5 s after the ramp up time or time to first puff has occurred. At the end of the first time period t0-t1 the controller may be configured to set progressively lower target operating temperatures. For example, after the end of the first time period t0-t1 the controller may be arranged to set a second target operating temperature T2 for the one or more aerosol generators. The second target operating temperature T2 may be 396° C. It will be understood that the second target operating temperature T2 is lower than the first target operating temperature T1. Other embodiments are contemplated wherein T2 may be 396±10° C. According to embodiments T2 may be 386-391° C., 391-396° C., 396-401° C. or 401-406° C. The controller may be configured to set the one or more aerosol generators the second target operating temperature T2 during a second time period t1-t2. The second time period t1-t2 may be 20 s. Other embodiments are contemplated wherein t1-t2 may be 20±10 s. According to embodiments t1-t2 may be 10-15 s, 15-20 s, 20-25 s or 25-30 s.

After the end of the second time period t1-t2 the controller may be arranged to set a progressively lower target operating temperature. For example, after the end of the second time period t1-t2 the controller may be arranged to set a third target operating temperature T3 for the one or more aerosol generators. The third target operating temperature T3 may be 394° C. It will be understood that the third target operating temperature T3 is lower than the second target operating temperature T2. Other embodiments are contemplated wherein T3 may be 394±10° C. According to embodiments T3 may be 384-389° C., 389-394° C., 394-399° C. or 399-404° C. The controller may be configured to set the one or more aerosol generators the third target operating temperature T3 during a third time period t2-t3. The third time period t2-t3 may be 20 s. Other embodiments are contemplated wherein t2-t3 may be 20±10 s. According to embodiments t2-t3 may be 10-15 s, 15-20 s, 20-25 s or 25-30 s.

At the end of the third time period t2-t3 the controller may be configured to set a yet further lower target operating temperature. For example, after the end of the third time period t2-t3 the controller may be arranged to set a fourth target operating temperature T4 for the one or more aerosol generators. The fourth target operating temperature T4 may be 392° C. It will be understood that the fourth target operating temperature T4 is lower than the third target operating temperature T3. Other embodiments are contemplated wherein T4 may be 392±10° C. According to embodiments T4 may be 382-387° C., 387-392° C., 392-397° C. or 397-402° C. The controller may be configured to set the one or more aerosol generators a fourth target operating temperature T4 during a fourth time period t3-t4. The fourth time period t3-t4 may be 20 s. Other embodiments are contemplated wherein t3-t4 may be 20±10 s. According to embodiments t3-t4 may be 10-15 s, 15-20 s, 20-25 s or 25-30 s.

At the end of the fourth time period t3-t4 the controller may be configured to set a yet further lower target operating temperature. For example, after the end of the fourth time period t3-t4 the controller may be arranged to set a fifth target operating temperature T5 for the one or more aerosol generators. The fifth target operating temperature T5 may be 390° C. It will be understood that the fifth target operating temperature T5 is lower than the fourth target operating temperature T4. Other embodiments are contemplated wherein T5 may be 390±10° C. According to embodiments T5 may be 380-385° C., 385-390° C., 390-395° C. or 395-400° C. The controller may be configured to set the one or more aerosol generators a fifth target operating temperature T5 during a fifth time period t4-t5. The fifth time period t4-t5 may be 20 s. Other embodiments are contemplated wherein t4-t5 may be 20±10 s. According to embodiments t3-t4 may be 10-15 s, 15-20 s, 20-25 s or 25-30 s.

At the end of the fifth time period t4-t5 the controller may be configured to set a yet further lower target operating temperature. For example, after the end of the fifth time period t4-t5 the controller may be arranged to set a sixth target operating temperature T6 for the one or more aerosol generators. The sixth target operating temperature T6 may be 386° C. It will be understood that the sixth target operating temperature T6 is lower than the fifth target operating temperature T5. Other embodiments are contemplated wherein T6 may be 386±10° C. According to embodiments T6 may be 376-381° C., 381-386° C., 386-391° C. or 391-396° C. The controller may be configured to set the one or more aerosol generators a sixth target operating temperature T6 during a sixth time period t5-t6. The sixth time period t5-t6 may be 20 s. Other embodiments are contemplated wherein t5-t6 may be 20±10 s. According to embodiments t5-t6 may be 10-15 s, 15-20 s, 20-25 s or 25-30 s.

At the end of the sixth time period t5-t6 the controller may be configured to set a yet further lower target operating temperature. For example, after the end of the sixth time period t5-t6 the controller may be arranged to set a seventh target operating temperature T7 for the one or more aerosol generators. The seventh target operating temperature T7 may be 384° C. It will be understood that the seventh target operating temperature T7 is lower than the sixth target operating temperature T6. Other embodiments are contemplated wherein T7 may be 384±10° C. According to embodiments T7 may be 374-379° C., 379-384° C., 384-389° C. or 389-404° C. The controller may be configured to set the one or more aerosol generators a seventh target operating temperature T7 during a seventh time period t6-t7. The seventh time period t6-t7 may be 20 s. Other embodiments are contemplated wherein t6-t7 may be 20±10 s. According to embodiments t6-t7 may be 10-15 s, 15-20 s, 20-25 s or 25-30 s.

At the end of the seventh time period t6-t7 the controller may be configured to set a yet further lower target operating temperature. For example, after the end of the seventh time period t6-t7 the controller may be arranged to set an eighth target operating temperature T8 for the one or more aerosol generators. The eighth target operating temperature T8 may be 382° C. It will be understood that the eighth target operating temperature T8 is lower than the seventh target operating temperature T7. Other embodiments are contemplated wherein T7 may be 382±10° C. According to embodiments T8 may be 372-377° C., 377-382° C., 382-387° C. or 387-402° C. The controller may be configured to set the one or more aerosol generators an eighth target operating temperature T8 during an eighth time period t7-t8. The eighth time period t7-t8 may be 20 s. Other embodiments are contemplated wherein t7-t8 may be 20±10 s. According to embodiments t7-t8 may be 10-15 s, 15-20 s, 20-25 s or 25-30 s.

At the end of the eighth time period t7-t8 the controller may be configured to set a yet further lower target operating temperature. For example, after the end of the eighth time period t7-t8 the controller may be arranged to set a ninth target operating temperature T9 for the one or more aerosol generators. The ninth target operating temperature T9 may be 380° C. It will be understood that the ninth target operating temperature T9 is lower than the eighth target operating temperature T8. Other embodiments are contemplated wherein T8 may be 380±10° C. According to embodiments T9 may be 370-375° C., 375-380° C., 380-385° C. or 385-400° C. The controller may be configured to set the one or more aerosol generators a ninth target operating temperature T9 during a ninth time period t8-t9. The ninth time period t8-t9 may be 20 s. Other embodiments are contemplated wherein t8-t9 may be 20±10 s. According to embodiments t8-t9 may be 10-15 s, 15-20 s, 20-25 s or 25-30 s.

With reference to the heating profile shown in FIG. 12 and as described above the total aerosol generation session length may be 180 s i.e. the session of use may be arranged to end after a total session of use length of 195 s wherein the aerosol provision device was ready for use after a ramp up time or time to first puff of 15 s (i.e. wherein time t0 to t_start was 15 s). It is noted that according to embodiments the maximum operating temperature set for the heater element may be approx. 380° C.

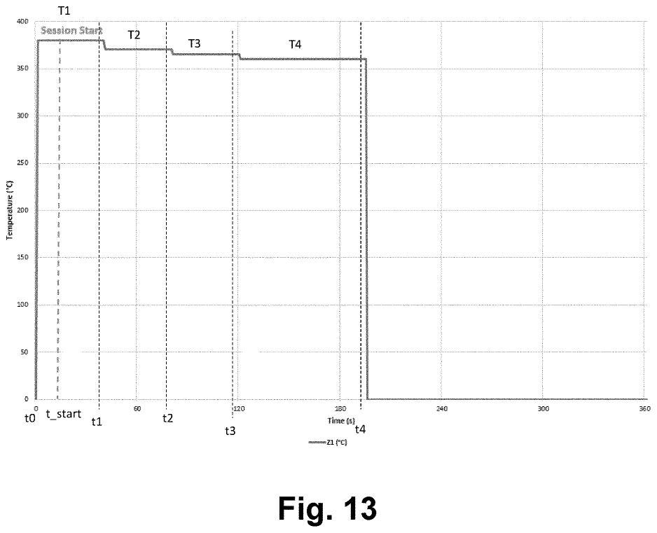

FIG. 13 shows a heating profile according to an embodiment and illustrates a heating profile which may be set by a controller (e.g. controller 420 as shown in FIG. 5) for an aerosol generator when an aerosol provision device is operated in a second or boost mode of operation. The second or boost mode of operation may be arranged to have a shorter aerosol generation session time of e.g. 180 s (i.e. 3 mins). The overall session of use may last for 195 s i.e. the overall session of use may comprise a 15 s ramp up time followed by a 180 s aerosol generation session.

The heating profile has four progressive steps down in time whilst the temperature is maintained ≥360° C. during the course of a session of use.

According to various embodiments the controller may be arranged to control the heater element to heat to a first target operating temperature T1 during a first time period t0-t1, to heat to a second target operating temperature T2 during a second time period t1-t2, to heat to a third target operating temperature T3 during a third time period t2-t3 and to heat to a fourth target operating temperature T4 during a fourth time period t3-t4. The temperature of the heater element may be arranged to progressively decrease during the progress of an aerosol generation session so that temperature T1>T2>T3>T4. It will also be understood that time to <t1<t2<t3<t4.

Time t0 may correspond with the time that a controller initially activates or turns on the aerosol generator or e.g. supplies a current to the heater element. The heater element may be set a first target operating temperature T1 but it may take a few seconds before the heater element either achieves the first target operating temperature T1 or a lower temperature which is sufficiently in order to cause aerosol to be generated. This initial time may be referred to as the ramp up time or time to first puff. An aerosol generation session may be considered as commencing after the ramp up time or time to first puff at a time t_start wherein to <t_start<t1. The time to t_start may be e.g. 10-20 s. With regards the heating profile shown in FIG. 8, t_start is 15 s after time t0.

The controller may be configured so that a heating mode is performed wherein as the temperature is progressively stepped down the desired operating temperature which is set remains ≥360° C. For example, according to embodiments the lowest target operating temperature T4 which may be set for the heater element during a session of use may be arranged to be ≥360° C.

The specific heating profile shown in FIG. 13 relates to a second or boost mode of operation wherein a user is afforded a total aerosol generation session time of approx. 180 s (i.e. 3 mins). According to this particular embodiment the time from t0 to t_start is 15 s and the time from t_start to t4 (when the aerosol generator or heating element is switched OFF) is 180 s.

| Profile Name | BOOST BST4/15/180/GD | | |
|---|---|---|---|
| Time to first puff | 15 s | | |
| (ramp up time) | | | |
| Cumulative time (s) | Profile step | Step (s) | Blade temp ° C. |
| 40 | 1 | 40 | 380 |
| 80 | 2 | 140 | 370 |
| 120 | 3 | 40 | 365 |
| 195 | 4 | 75 | 360 |

When the controller sets a heating profile such as the heating profile shown in FIG. 13, the controller may be arranged to so that a first target operating temperature T1 is achieved as quickly as possible thereby reducing the time to first puff. For example, with reference to the heating profile shown in FIG. 13 the first target operating temperature T1 set by the controller may be 380° C. Other embodiments are contemplated wherein the first target operating temperature T1 may be 380±10° C.

According to various embodiments the first target operating temperature T1 may be 370-375° C., 375-380° C., 380-385° C. or 385-390° C. The controller may be configured to set the heater element a first target operating temperature T1 during a first time period t0-t1. The first time period t0-t1 may be 40 s. Other embodiments are contemplated wherein t0-t1 may be 40±10 s. According to embodiments t0-t1 may be 30-35 s, 35-40 s, 40-45 s or 45-50 s.

A user may activate the aerosol provision device at a time to in order to cause the controller to set the one or more aerosol generators a desired heating profile. For example, a user may activate a user interface. Once a user has interacted with the user interface and the controller has set a desired heating profile for the one or more aerosol generators there may be a relatively short time delay (during time t0 to t_start) before the aerosol generator reaches a desired temperature and sufficient aerosol can be generated from an aerosol generating article at least partially inserted into the aerosol provision device. The time delay may be referred to as the ramp up time or time to first puff. As shown in FIG. 13, at the end of the ramp up time or once the time to first puff has passed (e.g. at time t_start) then an aerosol generation session may be considered as having commenced. In the case of the example shown in FIG. 13 the ramp up time or time to first puff (i.e. time t0 to t_start) is 15 s. However, according to other embodiments the ramp up time or time to first puff may be shorter or longer than 15 s e.g. 5-10 s, 10-15 s, 15-20 s or 20-25 s.

With regards the heating profile shown in FIG. 13, the controller may set the one or more aerosol generators a first target temperature T1 for e.g. a 40 s period of time immediately upon a user activating the aerosol provision device. If the time to first puff or the ramp up time is 15 s, then it will be understood that the controller may be configured to maintain the desired first target operating temperature T1 of e.g. 380° C. for a further 25 s after the ramp up time or time to first puff has occurred. At the end of the first time period t-t1 the controller may be configured to set progressively lower target operating temperatures. For example, after the end of the first time period t0-t1 the controller may be arranged to set a second target operating temperature T2 for the one or more aerosol generators. The second target operating temperature T2 may be 370° C. It will be understood that the second target operating temperature T2 is lower than the first target operating temperature T1. Other embodiments are contemplated wherein T2 may be 370±10° C. According to embodiments T2 may be 360-365° C., 365-370° C., 370-375° C. or 375-380° C. The controller may be configured to set the one or more aerosol generators the second target operating temperature T2 during a second time period t1-t2. The second time period t1-t2 may be 40 s. Other embodiments are contemplated wherein t1-t2 may be 40±10 s. According to embodiments t1-t2 may be 30-35 s, 35-40 s, 40-45 s or 45-50 s.

After the end of the second time period t1-t2 the controller may be arranged to set a progressively lower target operating temperature. For example, after the end of the second time period t1-t2 the controller may be arranged to set a third target operating temperature T3 for the one or more aerosol generators. The third target operating temperature T3 may be 365° C. It will be understood that the third target operating temperature T3 is lower than the second target operating temperature T2. Other embodiments are contemplated wherein T3 may be 365±10° C. According to embodiments T3 may be 355-360° C., 360-365° C., 365-370° C. or 370-375° C. The controller may be configured to set the one or more aerosol generators the third target operating temperature T3 during a third time period t2-t3. The third time period t2-t3 may be 40 s. Other embodiments are contemplated wherein t2-t3 may be 40±10 s. According to embodiments t2-t3 may be 30-35 s, 35-40 s, 40-45 s or 45-50 s.

At the end of the third time period t2-t3 the controller may be configured to set a yet further lower target operating temperature. For example, after the end of the third time period t2-t3 the controller may be arranged to set a fourth target operating temperature T4 for the one or more aerosol generators. The fourth target operating temperature T4 may be 360° C. It will be understood that the fourth target operating temperature T4 is lower than the third target operating temperature T3. Other embodiments are contemplated wherein T4 may be 360±10° C. According to embodiments T4 may be 350-355° C., 355-360° C., 360-365° C. or 365-370° C. The controller may be configured to set the one or more aerosol generators a fourth target operating temperature T4 during a fourth time period t3-t4. The fourth time period t3-t4 may be 75 s. Other embodiments are contemplated wherein t3-t4 may be 75±10 s. According to embodiments t3-t4 may be 65-70 s, 70-75 s, 75-80 s or 80-85 s.

With reference to the heating profile shown in FIG. 13 and as described above the total aerosol generation session length may be 180 s i.e. the session of use may be arranged to end after a total session of use length of 195 s wherein the aerosol provision device was ready for use after a ramp up time or time to first puff of 15 s (i.e. wherein time t0 to t_start was 15 s). It is noted that according to embodiments the maximum operating temperature set for the heater element may be approx. 380° C.

According to an alternative embodiment of the second or boost mode of operation, the controller sets a heating profile similar to FIG. 13. The heating profile has four progressive steps down in time whilst the temperature is maintained ≥410° C. during the course of a session of use.

| Profile Name | BOOST BST4/15/180/GD Alternative | | |
|---|---|---|---|
| Time to first puff | 15 s | | |
| (ramp up time) | | | |
| Cumulative time (s) | Profile step | Step (s) | Blade temp ° C. |
| 40 | 1 | 40 | 430 |
| 80 | 2 | 40 | 420 |
| 120 | 3 | 40 | 415 |
| 195 | 4 | 75 | 410 |

The first target operating temperature T1 set by the controller may be 430° C. Other embodiments are contemplated wherein the first target operating temperature T1 may be 430±10° C. According to various embodiments the first target operating temperature T1 may be 420-425° C., 425-430° C., 430-435° C. or 435-440° C.

The second target operating temperature T2 may be 420° C. It will be understood that the second target operating temperature T2 is lower than the first target operating temperature T1. Other embodiments are contemplated wherein T2 may be 420±10° C. According to embodiments T2 may be 410-415° C., 415-320° C., 420-425° C. or 425-430° C.

The third target operating temperature T3 may be 415° C. It will be understood that the third target operating temperature T3 is lower than the second target operating temperature T2. Other embodiments are contemplated wherein T3 may be 415±10° C. According to embodiments T3 may be 405-410° C., 410-415° C., 415-420° C. or 420-425° C.

The fourth target operating temperature T4 may be 410° C. It will be understood that the fourth target operating temperature T4 is lower than the third target operating temperature T3. Other embodiments are contemplated wherein T4 may be 410±10° C. According to embodiments T4 may be 400-405° C., 405-410° C., 410-415° C. or 415-420° C.

The maximum operating temperature set for the heater element may be approx. 430° C.

Said embodiments are otherwise the same as that described with respect to FIG. 13.

It will be understood that, whilst the above described heating profiles have been described as being suitable for a first (base) or a second (boost) mode of operation, any profile may be utilised as either a first (base) or a second (boost) mode of operation.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device configured to receive at least a portion of an article comprising aerosol generating material, the aerosol provision device comprising:
one or more aerosol generators arranged to cause aerosol to be generated from the aerosol generating material; and
a controller configured to control the one or more aerosol generators during a session of use, wherein during the session or use the controller is configured to control the one or more aerosol generators:
(i) to heat to a first target operating temperature T1 during a first time period t0-t1;
(ii) to heat to a second target operating temperature T2 during a second time period t1-t2;
(iii) to heat to a third target operating temperature T3 during a third time period t2-t3; and
(iv) to heat to a fourth target operating temperature T4 during a fourth time period t3-t4;
wherein temperature T1<T2<T3<T4 and time t0<t1<t2<3<t4; and
wherein T1>300° C.

2. An aerosol provision device as claimed in claim 1, wherein: (i) T1=320±10° C.; (ii) T2=325±10° C.; (iii) T3=330±10° C.; and (iv) T4=335±10° C.

3. An aerosol provision device as claimed in claim 1, wherein: (i) T1=370±10° C.; (ii) T2=375±10° C.; (iii) T3=380±10° C.; and (iv) T4=385±10° C.

4. (canceled)

5. An aerosol provision device as claimed in claim 1, wherein the controller is further configured to control the one or more aerosol generators:
(v) to heat to a fifth target operating temperature T5 during a fifth time period t4-t5;
(vi) to heat to a sixth target operating temperature T6 during a sixth time period t5-t6;
(vii) to heat to a seventh target operating temperature T7 during a seventh time period t6-t7;
(viii) to heat to an eighth target operating temperature T8 during an eighth time period t7-t8; and
(ix) to heat to a ninth target operating temperature T9 during a ninth time period t8-t9;
wherein T4<T5<T6<T7<T8<T9 and time t4<15<t6<t7<t8<t9.

6. An aerosol provision device as claimed in claim 5, wherein: (i) T5=340±10° C.; (ii) T6=350±10° C.; (iii) T7=360±10° C.; (iv) T8=370±10° C.; and (v) T9=380±10° C.

7. An aerosol provision device as claimed in claim 5, wherein: (i) T5=390±10° C.; (ii) T6=400±10° C.; (iii) T7=410±10° C.; (iv) T8=420±10° C.; and (v) T9=430±10° C.

8. (canceled)

9. An aerosol provision device as claimed in claim 1, wherein: (i) T1=360±10° C.; (ii) T2=365±10° C.; (iii) T3=370±10° C.; and (iv) T4=375±10° C.

10. An aerosol provision device as claimed in claim 1, wherein: (i) T1=410±10° C.; (ii) T2=415±10° C.; (iii) T3=420±10° C.; and (iv) T4=425±10° C.

11. (canceled)

12. An aerosol provision device as claimed in claim 1, wherein the controller is further configured to control the one or more aerosol generators:
(v) to heat to a fifth target operating temperature T5 during a fifth time period t4-t5; wherein T4<T5 and time t4<t5.

13. An aerosol provision device as claimed in claim 12, wherein: (i) T5=380±10° C.

14. An aerosol provision device as claimed in claim 12, wherein: (i) T5=430±10° C.

15. (canceled)

16. An aerosol provision device configured to receive at least a portion of an article comprising aerosol generating material, the aerosol provision device comprising:
one or more aerosol generators arranged to cause aerosol to be generated from the aerosol generating material; and
a controller configured to control the one or more aerosol generators during a session of use, wherein during the session or use the controller is configured to control the one or more aerosol generators:
(i) to heat to a first target operating temperature T1 during a first time period t0-t1;
(ii) to heat to a second target operating temperature T2 during a second time period t1-t2;
(iii) to heat to a third target operating temperature T3 during a third time period t2-t3; and
(iv) to heat to a fourth target operating temperature T4 during a fourth time period t3-t4;
wherein temperature T1>T2, temperature T2<T3<T4 and time t0<t1<t2<t3<t4; and
wherein T1>300° C.

17. An aerosol provision device as claimed in claim 16, wherein T1>T3, and optionally T1>T4.

18. An aerosol provision device as claimed in claim 16, wherein: (i) T1=400±10° C.; (ii) T2=350±10° C.; (iii) T3=355±10° C.; and (iv) T4=360±10° C.

19. (canceled)

20. An aerosol provision device as claimed in claim 16, wherein the controller is further configured to control the one or more aerosol generators:
(v) to heat to a fifth target operating temperature T5 during a fifth time period t4-t5;
(vi) to heat to a sixth target operating temperature T6 during a sixth time period t5-t6;
(vii) to heat to a seventh target operating temperature T7 during a seventh time period t6-t7;
(viii) to heat to an eighth target operating temperature T8 during an eighth time period t7-t8; and
(ix) to heat to a ninth target operating temperature T9 during a ninth time period t8-t9;
wherein T4<T5<T6<T7<T8<T9 and time t4<15<t6<t7<t8<t9.

21. An aerosol provision device as claimed in claim 20, wherein T1>T4, optionally T1>T5, optionally T1>T6, optionally T1>T7, optionally T1>T8, optionally T1>T9.

22. An aerosol provision device as claimed in claim 20, wherein T1=T9.

23. An aerosol provision device as claimed in claim 20, wherein: (i) T5=370±10° C.; (ii) T6=375±10° C.; (iii) T7=380±10° C.; and (iv) T8=390±10° C.; and (v) T9=400=10° C.

24.-31. (canceled)

32. An aerosol provision system comprising:
an aerosol provision device as claimed in claim 1; and
an article comprising aerosol generating material.

33. (canceled)

34. A method of generating an aerosol comprising:
providing an aerosol provision device as claimed in claim 1;
at least partially inserting an article comprising aerosol generating material into a receiving portion of a heating chamber of the aerosol provision device; and
activating the aerosol provision device in order to generate aerosol from the article.
